(19) United States
(12) Patent Application Publication
(10) Pub. No.: US 2025/0165460 A1
(43) Pub. Date: May 22, 2025

(54) TECHNIQUES FOR PROTECTIVE VALIDATION IN A NON-DISTRIBUTED DATABASE

(71) Applicant: Regatta Data Ltd., Bet Hanania (IL)

(72) Inventors: Erez WEBMAN, Petach Tikva (IL); Irit YADIN-LEMPEL, Caesarea (IL); Nitzan ZAMIR, Binyamina (IL); Roy Zeev GOLDSTEIN, Zikhron Ya'akov (IL)

(73) Assignee: Regatta Data Ltd., Bet Hanania (IL)

(21) Appl. No.: 18/945,062

(22) Filed: Nov. 12, 2024

Related U.S. Application Data
(60) Provisional application No. 63/600,145, filed on Nov. 17, 2023.

(51) Int. Cl. G06F 16/23

(52) U.S. Cl. CPC G06F 16/2379

(57) ABSTRACT

A system and method for managing execution of database transactions in a non-distributed database system is presented. The method includes, during a validation of a transaction, identifying conditional conflicts and their corresponding conflicting transactions, wherein the corresponding conflicting transactions are reading-transactions conflicting with the transaction; for each conditional conflict, determining if the transaction can commit, with respect to the conditional conflict, before the corresponding conflicting transaction; placing an active protective declaration, issued by the transaction and sourced by a corresponding conflicting transaction, when the transaction can commit, with respect to the conditional conflict, before the corresponding conflicting transaction; marking the transaction as dependent on the corresponding conflicting transaction when the transaction cannot commit before the corresponding conflicting transaction; and when validation conditions are met, placing a commit pause on data cells modified by the transaction, thereby allowing the transaction to commit before any corresponding conflicting transactions.

### CROSS-REFERENCE TO RELATED APPLICATIONS

This application claims the benefit of U.S. Provisional Application No. 63/600,145 filed on Nov. 17, 2023, the contents of which are hereby incorporated by reference. The subject matter of the present application relates to U.S. patent application Ser. No. 18/591,615 filed Feb. 29, 2024. The contents of the Ser. No. 18/591,615 application are hereby incorporated by reference. The subject matter of the present application relates to U.S. patent application Ser. No. 18/944,462 filed Nov. 12, 2024, the contents of the Ser. No. 18/944,462 application are hereby incorporated by reference.

### TECHNICAL FIELD

The present disclosure generally relates to databases and, specifically, techniques for the implementation of protective validation techniques of a predictive concurrency control protocol to maintain the serializability of concurrent operations in such databases.

### BACKGROUND

In databases, concurrency control protocols ensure correct results for concurrent operations are generated as quickly as possible. Typically, a concurrency control protocol provides rules and methods typically applied by the database mechanisms to maintain the consistency of transactions operating concurrently and, thus, the consistency and correctness of the whole database. Introducing concurrency control into a database would apply operation constraints which typically result in some performance reduction. Operation consistency and correctness should be achieved as efficiently as possible without reducing the database's performance. However, a concurrency control protocol can require significant additional complexity and overhead in a concurrent algorithm compared to a simpler sequential algorithm.

A concurrency control protocol can be implemented in database management systems, transactional objects, and distributed applications. Such a protocol is designed to ensure that database transactions may be performed concurrently without violating the data integrity of the respective databases. Thus, concurrency control is an essential element for correctness in any database system where two database transactions or more, executed with time overlap, can access the same data, e.g., in virtually any general-purpose database system. There are different approaches to implementing a concurrency control protocol (or mechanism) in databases. The main approaches may be categorized as optimistic approaches and pessimistic approaches.

In some optimistic approaches, a check for whether a transaction meets the isolation and other integrity rules (e.g., serializability) is typically performed when the transaction ends, without blocking any of the transaction's operations. Other optimistic approaches check whether a transaction meets the isolation and other integrity rules (e.g., serializability), without blocking any of the transaction's operations. When the isolation of the transaction is violated, the transaction is aborted. An aborted transaction may be immediately restarted and re-executed, which incurs an overhead. As such, if too many transactions are aborted, the optimistic approach may be disadvantageous. In a pessimistic approach, an operation of a transaction is blocked when such an operation may cause a violation of consistency rules. In such cases, the operation is blocked until the possibility of violation of the transaction clears. The disadvantage of blocking operations involves performance reduction.

Different approaches for concurrency control in databases provide different levels of performance. The selection of the best-performing approach may be based on the type of transactions, the required performance, the type of databases, and the applications accessing the database. However, the selection and knowledge about trade-offs are not always available, and thus the implemented concurrency control approach may not be selected to provide the highest performance.

Further, some databases are designed where Atomicity, Consistency, Isolation, Durability (ACID) requirements are relaxed. In such databases, as multiple transactions can execute concurrently and independently of each other, such transactions may overlap in their access to data. This could result in various inconsistencies. One method to ensure isolation between transactions and serialization in execution is by means of a well-designed concurrency control protocol.

Furthermore, existing concurrency control protocols are not efficient for transactions that include one or more predicates. Specifically, such protocols require placing locks or pausing the execution of transactions regardless of the states of the transactions' predicates. In databases, a predicate is a conditional (i.e., Boolean) expression that returns TRUE or FALSE. Predicates are commonly used in statements sent to databases, and are often an inherent part of the database statement syntax or language. For example, a common usage of predicates would be to conditionally modify a data-cell(s) based on a condition that is based on data-cell(s). Another use of predicates in a relational database is when selecting one or more rows in a table. The selected rows are those for which the predicate evaluation, based on the contents of the row, returns TRUE. These selected rows can then be further acted upon.

It would, therefore, be advantageous to provide an improved concurrency control protocol for optimizing the performance of databases when executing transactions with predicates.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include, during a validation of a transaction, identifying conditional conflicts and their corresponding conflicting transactions, where the corresponding conflicting transactions are reading-transactions conflicting with the transaction; for each conditional conflict, determining if the transaction can commit, with respect to the conditional conflict, before the corresponding conflicting transaction; placing an active protective declaration, issued by the transaction and sourced by a corresponding conflicting transaction, when the transaction can commit, with respect to the conditional conflict, before the corresponding conflicting transaction; marking the transaction as dependent on the corresponding conflicting transaction when the transaction cannot commit before the corresponding conflicting; when validation conditions are met, placing a commit pause on data cells modified by the transaction, thereby allowing the transaction to commit before any corresponding conflicting transactions. Other embodiments of this aspect include corresponding computer systems, apparatus, and computer programs recorded on one or more computer storage devices, each configured to perform the actions of the methods.

The above method may also include: identifying non-conditional conflicts and their related conflicting transactions. The validation conditions of the method may include: the transaction is neither conditionally dependent nor non-conditionally dependent on any conflicting transactions; all non-conditional conflicts are processed; all conditional conflicts are processed; the transaction does not have any evaluation-pending validations or evaluation-deferred validations; and any active protective declarations issued by the transaction are not in use by a challenging process. The method may include waiting until the validation conditions are met. The method may include processing all non-conditional conflicts. The method may include: for each non-conditional conflict, marking the transaction as dependent on the corresponding conflicting transaction; and removing any protective declarations issued by the transaction that were sourced by the corresponding conflicting transaction. The method may include processing all conditional conflicts. The method may include: checking if an epsilon checking procedure can be performed; when the epsilon checking procedure can be processed: performing an epsilon checking procedure on the transaction to determine if an epsilon principle is satisfied, where the epsilon checking procedure evaluates a value of a predicate on a data cell set immediately before and immediately after committing the transaction; issuing the active protective declaration for a specific predicate of a data-cell set, when the epsilon principle is satisfied; and issuing an inactive conditionally-dependent protective declaration for a specific predicate on a specific data-cell set, when the epsilon principle is not satisfied. The method may include: when the epsilon checking procedure cannot be performed: issuing an inactive evaluation-pending protective declaration, sourced by the conflicting transaction, where the inactive evaluation-pending protective declaration is issued for a specific predicate on a specific data-cell-set. The method may include committing the transaction immediately after placing the commit pause on data cells modified by the transaction. The method may include releasing the commit pause; removing non-conditional dependencies of other transactions on the transaction; removing all the active protective declarations issued by the transaction; and removing all protective declarations sourced by the transaction. Where the corresponding conflicting transaction is a reading-transaction, reading data cells, by the reading-transaction, may include: creating a read vector entry in a read-vector of the reading-transaction; scanning write vectors of other pending transactions to identify conflicting writing-transactions; for each identified conflicting writing-transactions, sending a validation message to the conflicting writing-transaction; and reading the data cells by the reading-transaction. A conditional conflict is determined, according to the method, based, in part, on at least one predicate in the corresponding conflicting transaction. According to the method, a state of a conditional conflict is determined as a stay-in state when evaluated values of the at least one predicate on a data cell set immediately before and immediately after committing the transaction are a Boolean value true, where the stay-in state provides that there is no potential dependency between the transaction and the corresponding conflicting transaction with respect to the conditional conflict. According to the method, a state of a conditional conflict is determined as a stay-out state when evaluated values of the at least one predicate on a data cell set immediately before and immediately after committing the transaction is a Boolean value false, where the stay-out state provides that there is no potential dependency between the transaction and the corresponding conflicting transaction with respect to the conditional conflict. According to the method, a state of a conditional conflict is determined as a move-in state when evaluated values of the at least one predicate on a data cell set immediately before committing the transaction is a Boolean value false, and the evaluated value of the predicate immediately after committing the transaction is a Boolean value true, where the move-in state does not allow the transaction to commit before the corresponding conflicting transaction. According to the method, a state of a conditional conflict is determined as a move-out state when evaluated values of the at least one predicate on a data cell set immediately before committing the transaction is a Boolean value true, and the evaluated value of the predicate immediately after committing the transaction is a Boolean value false, where the move-out state does not allow the transaction to commit before the corresponding conflicting transaction. According to the method, tasks in the transaction are executed in an optimistic manner, and the transaction is validated in a pessimistic manner. The method may include resolving pseudo-deadlocks by applying a forced challenging procedure. Implementations of the described techniques may include hardware, a method or process, or a computer tangible medium.

In one general aspect, a non-transitory computer-readable medium may include one or more instructions that, when executed by one or more processors of a device, cause the device to: during a validation of a transaction, identify conditional conflicts and their corresponding conflicting transactions, where the corresponding conflicting transactions are reading-transactions conflicting with the transaction; for each conditional conflict, determine if the transaction can commit, with respect to the conditional conflict, before the corresponding conflicting transaction; place an active protective declaration, issued by the transaction and sourced by a corresponding conflicting transaction, when the transaction can commit, with respect to the conditional conflict, before the corresponding conflicting transaction; mark the transaction as dependent on the corresponding conflicting transaction when the transaction cannot commit before the corresponding conflicting transaction; when validation conditions are met, place a commit pause on data cells modified by the transaction, thereby allowing the transaction to commit before any corresponding conflicting transactions. Other embodiments of this aspect include corresponding computer systems, apparatus, and computer programs recorded on one or more computer storage devices, each configured to perform the actions of the methods.

In one general aspect, a system for managing execution of database transactions may include one or more processors configured to: during a validation of a transaction, identify conditional conflicts and their corresponding conflicting transactions, where the corresponding conflicting transactions are reading-transactions conflicting with the transaction; for each conditional conflict, determine if the transaction can commit, with respect to the conditional conflict, before the corresponding conflicting transaction; place an active protective declaration, issued by the transaction and sourced by a corresponding conflicting transaction, when the transaction can commit, with respect to the conditional conflict, before the corresponding conflicting transaction; mark the transaction as dependent on the corresponding conflicting transaction when the transaction cannot commit before the corresponding conflicting transaction; when validation conditions are met, place a commit pause on data cells modified by the transaction, thereby allowing the transaction to commit before any corresponding conflicting transactions. Other embodiments of this aspect include corresponding computer systems, apparatus, and computer programs recorded on one or more computer storage devices, each configured to perform the actions of the methods.

The one or more processors of the system for managing execution of database transactions are further configured to: identify non-conditional conflicts and their related conflicting transactions The validation conditions of the system include: the transaction is neither conditionally dependent nor non-conditionally dependent on any conflicting transactions; all non-conditional conflicts are processed; all conditional conflicts are processed; the transaction does not have any evaluation-pending validations or evaluation-deferred validations; and any active protective declarations issued by the transaction are not in use by a challenging process. The one or more processors of the system are further configured to wait until the validation conditions are met. The one or more processors of the system are further configured to process all non-conditional conflicts. The one or more processors of the system are further configured to: for each non-conditional conflict, mark the transaction as dependent on the corresponding conflicting transaction; and remove any protective declarations issued by the transaction that were sourced by the corresponding conflicting transaction. The one or more processors of the system are further configured to process all conditional conflicts The one or more processors of the system are further configured to: check if an epsilon checking procedure can be performed; when the epsilon check procedure can be performed: perform an epsilon checking procedure on the transaction to determine if an epsilon principle is satisfied, where the epsilon checking procedure evaluates a value of a predicate on a data cell set immediately before and immediately after committing the transaction; issue the active protective declaration for a specific predicate of a data-cell set, when the epsilon principle is satisfied; and issue an inactive conditionally-dependent protective declaration for a specific predicate on a specific data-cell set, when the epsilon principle is not satisfied. The one or more processors of the system are further configured to: when the epsilon check procedure cannot be performed: issue an inactive evaluation-pending protective declaration, sourced by the conflicting transaction, where the inactive evaluation-pending protective declaration is issued for a specific predicate on a specific data-cell-set. The one or more processors of the system are further configured to: commit the transaction immediately after placing the commit pause on data cells modified by the transaction. The one or more processors of the system are further configured to: release the commit pause; remove non-conditional dependencies of other transactions on the transaction; remove all the active protective declarations issued by the transaction; and remove all protective declarations sourced by the transaction. According to the system, the one or more processors are configured to, when the corresponding conflicting transaction is a reading-transaction: create a read vector entry in a read-vector of the reading-transaction; scan write vectors of other pending transactions to identify conflicting writing-transactions; for each identified conflict writing-transactions, send a validation message to the conflicting writing-transaction; and read the data cells by the reading-transaction. According to the system, a conditional conflict is determined based, in part, on at least one predicate in the corresponding conflicting transaction. According to the system, a state of a conditional conflict is determined as a stay-in state when evaluated values of the at least one predicate on a data cell set immediately before and immediately after committing the transaction are a Boolean value true, the stay-in state provides that there is no potential dependency between the transaction and the corresponding conflicting transaction with respect to the conditional conflict. According to the system, a state of a conditional conflict is determined as a stay-out state when evaluated values of the at least one predicate on a data cell set immediately before and immediately after committing the transaction is a Boolean value false, the stay-out state provides that there is no potential dependency between the transaction and the corresponding conflicting transaction with respect to the conditional conflict According to the system, a state of a conditional conflict is determined as a move-in state when evaluated values of the at least one predicate on a data cell set immediately before committing the transaction is a Boolean value false, and the evaluated value of the predicate immediately after committing the transaction is a Boolean value true, the move-in state does not allow the transaction to commit before the corresponding conflicting transaction According to the system, a state of a conditional conflict is determined as a move-out state when evaluated values of the at least one predicate on a data cell set immediately before committing the transaction is a Boolean value true, and the evaluated value of the predicate immediately after committing the transaction is a Boolean value false, the move-out state does not allow the transaction to commit before the corresponding conflicting transaction. According to the system, tasks in the transaction are executed in an optimistic manner, and the transaction is validated in a pessimistic manner. The one or more processors of the system are further configured to: resolve pseudo-deadlocks by applying a forced challenging procedure. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a computing environment utilized to describe the various disclosed embodiments.

FIG. 2 is a block diagram of a database system arranged according to an embodiment.

FIG. 3 is a flowchart of a method of operation of a transaction manager, according to an embodiment.

FIG. 4 is a flowchart of a method of operation of an agent executed on a node during a validation phase and a commit phase of a transaction according to an embodiment.

FIG. 5 is a flowchart describing the operation of a validation-phase of the predictive CCP according to one embodiment.

FIG. 6 is an example flowchart showing a process for processing a non-conditional conflict according to an embodiment.

FIG. 7 is a flowchart showing a process for processing a conditional conflict according to an embodiment.

FIG. 8 is a flowchart illustrating the operation of committed-message handling procedure.

FIG. 9 is a flowchart illustrating a process for reading data cells according to various embodiments.

FIG. 10 is a schematic diagram of a database node according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, numerals refer to like parts through several views.

Some example embodiments provide a predictive concurrency control protocol (CCP) with protective validation techniques implemented into a database system (or simply a database). According to the disclosed embodiments, consistency of transactions, by means of the disclosed predictive CCP, is achieved through isolating transactions and adopting different approaches during the execution phases of a transaction. In an embodiment, an optimistic approach is implemented during the working-phase of a transaction to allow the operation of multiple transactions to run independently without blocking or locks. For validation of a transaction, a pessimistic approach is taken, where a validating transaction may wait for other transaction(s) to commit, and where, under some circumstances, a transaction that evaluated predicates may not block other validating transaction(s) from committing. This is achieved by predicting the value of such predicates in a transaction being validated. The prediction of values of such predicates for data-cells is achieved, in some embodiments, through an epsilon checking procedure, discussed in detail below. According to the disclosed embodiments, various protective declarations are used to block other transactions from modifying the contents of the data-cells when it is determined by the epsilon checking procedure that a transaction may commit early. Additional disclosed embodiments include techniques for efficiently handling conflicts and deadlocks between transactions. As a result of these embodiments, significantly fewer transactions are aborted in comparison to a known implementation of an optimistic concurrency control protocol, thereby improving the overall performance of the databases. Further, significantly more transactions can be executed and committed in parallel than with a known implementation of an optimistic concurrency control protocol. Thus, the disclosed embodiments allow for higher parallelism in the transaction working-phase, execution, and validation-phases.

As such, the disclosed techniques allow for the fast execution of transactions and the processing of more transactions at a given time period. Therefore, the disclosed embodiments provide a technical improvement over current database systems that, in most cases, fail to serve applications that require fast and parallel execution of transactions for retrieval and modification of datasets. The disclosed embodiments can be implemented in database systems as well as in data management systems, such as an object storage system, a key-value storage system, a file-system, and the like.

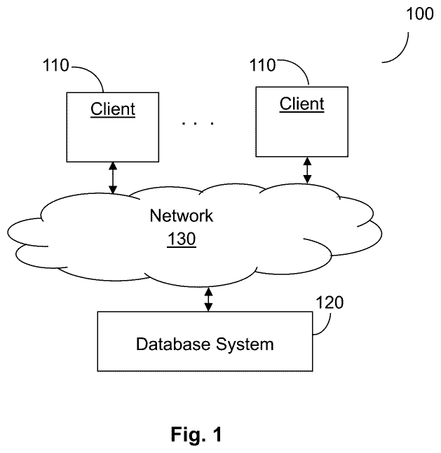

FIG. 1 shows an example network diagram 100 of a computing environment utilized to describe the various disclosed embodiments. In the example network diagram 100, a plurality of clients 110 and a database system (or simply database) 120 are connected to a network 130. In one configuration, database 120 is a non-distributed database. Network 130 may be, but is not limited to, wireless, cellular, or wired network, a local area network (LAN), a wide area network (WAN), a metro area network (MAN), the Internet, the worldwide web (WWW), similar networks, and any combination thereof.

Each client 110 is configured to access the database 120 through the execution of transactions. A client 110 may include any computing device executing applications, services, processes, and so on. A client 110 can run a virtual instance (e.g., a virtual machine, a software container, and the like).

In some configurations, clients 110 may be software entities that interact with the database 120. Clients 110 are typically located in compute nodes that are separate from database 120 and communicate with database 120 via an interconnect or over a network. In some configurations, an instance of a client 110 can reside in a node is part of the database 120.

The database 120 may be designed according to a shared-nothing or a shared-everything architecture. The transactions to database 120 are processed without locks placed on data entries in database 120. This allows for fast processing retrieval and modifications of data sets.

A transaction is issued by a client 110, processed by the database 120, and the results are returned to the client 110. A transaction typically includes the execution of various data-related operations over the database system 120. These operations are often originated by clients 110. The execution of such operations may be short or lengthier. In many cases, operations are independent and unaware of each other's progress.

A transaction can be viewed as an algorithmic program logic that potentially involves reading and writing various data-cells. A transaction, for example, may read some data-cells through one data operation, and then, based on the values read, can decide to modify other data-cells. That is, a transaction is not just an “I/O operation” but is more of a “true” computer program. A data cell is one cell of data. Data cells may be organized and stored in various formats and ways. Data cells, defined below, may be contained in files or other containers, and can represent different types (integer, string, and so on).

An execution of a transaction may be shared between a client and the database 120. For instance, in an SQL-based relational database, a client 110 interacts with the database using SQL statements. A client 110 can begin a transaction by submitting a SQL statement. That SQL statement is executed by the database 120. Depending on the exact SQL statement, the database 120 performs various read and/or write operations as well as invokes algorithmic program logic typically to determine which (and whether) data-cells are read and/or written. Once that SQL statement completes, the transaction is generally still in progress. The client 110 receives the response for that SQL statement and potentially executes some algorithmic program logic (inside the client node) that may be based on the results of the previous SQL commands, and as a result of that additional program logic, may submit an additional SQL statement and so on and so forth. At a certain point, and once the client 110 receives an SQL statement response, the client can instruct the database 120 to commit the transaction.

It should be noted that a client 110 can submit a transaction as a whole to the database 120, and/or submit multiple statements for the same transaction together, and/or submit a statement to the database 120 with an indication for the database to commit after the database 120 completes the execution of that statement.

It should be further noted that transactions may be abortable by the database 120 and/or a client 110. Often, aborting a transaction clears any of the transaction's activities.

For the sake of simplicity and ease of description, the following description would refer to a transaction initiated and committed by a client, and statements of the transaction are performed by the database 120. A transaction may include one or more statements. A statement may include, for example, an SQL statement. One of the statements may include a request to commit the transaction. In order to execute such a statement, the database may break the statement execution into one or more tasks, where each such task is running on a node. With this modeling, a task does not execute on more than a single node, but multiple tasks of the same statement can execute on the same node if needed. A task is an algorithmic process that may require the execution of read operation(s) and/or write operations(s) on data cells.

As defined herein without any limitation, a “writing-transaction” refers to a transaction that writes data-cells. A writing-transaction may also read data-cells. Note that any write-only transaction is also a writing-transaction, but the opposite is not correct. Reading-transaction” refers to a transaction that reads data-cells. A reading-transaction can also write data-cells. It should be noted that any read-only transaction is also a reading transaction, but the opposite is not correct. A validating-transaction is a transaction being validated.

As part of its execution, a statement may evaluate one or more predicates. A predicate is a conditional (i.e., Boolean) expression that returns TRUE or FALSE. Predicates are commonly used in statements sent to databases and are often an inherent part of the database statement syntax or language. For example, a common usage of predicates would be to conditionally modify a data-cell(s) based on a condition (predicate) that is based on data-cell(s).

As an example, consider the following data-cells: john_hair_color. john_profession, john_salary, john_start_date; and the following a statement:
IF ((john_profession=software_engineer) AND (john_start_date<1.1.2010)) THEN
   john_salary=john_salary*1.10
   john_profession=senior_software_engineer

The predicate is the IF expression and can return TRUE if john is both a software engineer AND started to work earlier than 2010, or FALSE, otherwise. The conditional actions are setting john_profession to a senior software engineer and raising his salary by 10%.

A statement evaluating predicates may consider the value of “Predicate Data-Cells” which are data-cells that were used to calculate the predicate. In the above example, those are john_profession and john_start_date. Another way to term this would be that the predicate is evaluating a single Data-Cell Set, where that data-cell set is (john_profession, john_start_date).

In databases, a statement can be executed on a single, specific row, where that statement involves a predicate (or multiple predicates), where each predicate evaluates a single data-cell set that is often associated with that row.

In addition, in relational databases, as well as in some non-relational databases, it is also possible to perform a statement on a set of rows where the specific identity of the rows is not explicitly known. Instead, the rows are selected according to various criteria and are often selected by a predicate.

For example, in a relational database with an employee table (a row represents each employee), the following SQL statement is performed: “For all the employees that have a profession of software engineer and started to work in the company earlier than 2010, modify their profession to senior_software_engineer and raise their salary by 10%”. It should be noted that the SQL statements provided herein are not in their proper SQL syntax.

In that case, the scope of the statement is the entire table, and so is the scope of the predicate. While the predicate data-cells are actually the entire profession and start_date columns (i.e., all the corresponding cells for all the rows in the table), the predicate operates, each time, on a separate data-cell set. Such a data-cell set would be, for example, the cells: John's profession and John's start_date. The predicate will also operate on Betty's profession and Betty's start_date (yet another relevant data-cell set). However, inherently, according to the statement semantics, the predicate will not operate on John's profession together with Betty's start_date.

A transaction may be executed over the database 120 in three phases: working, validation, and commit. In some configurations, a transaction may be executed over the database 120 in two phases: working and commit. The embodiments carried by the disclosed predictive concurrency control protocol in each phase are discussed in great detail below.

In the disclosed configuration, the database 120 is a non-distributed database and may be realized as a relational database system (RDBMS) or a non-relational database. Typically, a non-distributed database is a configuration of a node that may be situated in one physical location. Also, in a non-distributed database, a node is generally a computer. However, it can also be a virtual server, a user-mode process, a combination thereof, or the like.

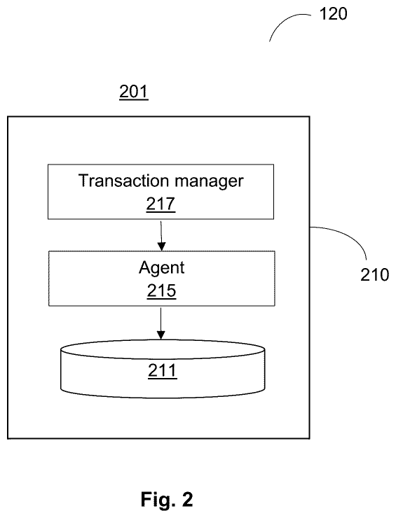

The disclosed embodiments will be discussed with reference to a non-distributed database configuration. However, the disclosed embodiments are also applicable to a distributed configuration of a database. FIG. 2 shows an example diagram of a non-distributed database 120 arranged according to an embodiment. Database 120 operates with one node 210 as a non-distributed arrangement. Node 210 may be realized as a physical device or a virtual instance executed on a physical device. A virtual device may include a virtual machine, a software container, a service, and the like. The physical device, an example of which is disclosed below, includes a least a processing circuitry, and a memory (not shown). A physical device may also include a storage 211. Storage 211 stores the data maintained by the database 120. The storage may be realized as magnetic storage, optical storage, and the like, and may be realized, for example, as flash memory or other memory technology or any other medium that can be used to store the desired information. Storage 211 may be internal or external to a node 210.

Node 210 may be deployed in a data center, a cloud computing platform, and the like. The communication and synchronization of node 210 and external devices may be performed through an interconnect network or a communication bus 201.

The data managed by the database and stored in storage 211 can be viewed as a set of data cells. While the most natural form of those data cells would be items, such as what relational databases refer to as “column cells,” those data cells can actually be any type of data, data object, file, and the like.

Databases often organize a higher level of a data object referred to as data-row (or simply row). A data-row may include a collection of specific data-cells. For example, in relational databases, a set of rows form a database table. The data-cells contained by a specific row are often related to one “entity” that the row describes. In relational databases, the concept of a data-row is inherent to the data-model (i.e., one of the foundations of the relational data-model is processing “data tuples” that are effectively data-rows). Often, data-cells can be added or removed only as part of their data-row. In other words, a data-row can be added (or removed), thus adding more (or removing existing) data-cells to the database.

Typically, all the data-cells of a specific row reside in close proximity (e.g., consecutively) on the storage device, as this can ensure that multiple cells of the same row (or all the cells of the row) can be read from the disk more cheaply (e.g., with a single small disk I/O) than if those cells would each be stored elsewhere on the disk (e.g., with n disk I/Os to n different disk locations in order to retrieve n cells of the same row). Further, the metadata for managing the data cell information may also be organized in a rougher resolution as it may result in meaningfully lesser and smaller overall metadata.

In some embodiments, a specific data-row can be viewed as if it exists and just contains a single specific data-cell. In one configuration, and without limiting the scope of the disclosed embodiments, a single cell, and a single row may reside in a specific storage device of node 210. It should be further noted that the disclosed embodiments can be adapted to operate in databases where data cells are stored and arranged in different structures.

In another embodiment, and without limiting the scope of the disclosed embodiments, the database may also store various pieces of data, in addition to the data-cells and data-rows, including, but not limited to, any and all metadata, various data structures, configuration information, a combination thereof, and the like (hereinafter “metadata”). Additionally, in an embodiment, and without limiting the scope of the disclosed embodiments, the database may also store index information that may be used, for example, for faster searching of data-rows.

In some embodiments, an operation of a task may access a single data cell in node 210. Furthermore, multiple operations (of the same or different transactions) may access the same data cells simultaneously or substantially at the same time. There is no synchronization when such operations, tasks, or statements of a transaction or transactions are performed. In a typical computing environment, hundreds of concurrent transactions can access the database 120. As such, maintaining and controlling the consistency of transactions and their operations is a critical issue to resolve in databases.

In an embodiment, node 210 includes an agent 215 and a transaction manager 217. Agent 215 is configured to manage access to data stored on the node. Agent 215 may be realized in hardware, software, firmware, or a combination thereof. Software shall be construed broadly to mean any type of instructions, whether referred to as software, firmware, middleware, microcode, hardware description language, or otherwise. Instructions may include code (e.g., in source code format, binary code format, executable code format, or any other suitable format of code).

Agent 215 is configured to manage the contents of data cells and operations within node 210. For example, when a write operation requires access to data cell(s), agent 215 may be configured to point to the requested cell(s). In an embodiment, each transaction is managed by a transaction manager 217. A transaction manager 217 is an instance executed over node 210 and configured to orchestrate the execution of a transaction. The transaction manager 217 can be realized as a software object, a script, and the like executed over the hardware of node 210. It should be noted that multiple transaction managers may be executed on node 210, where each transaction manager handles a single transaction.

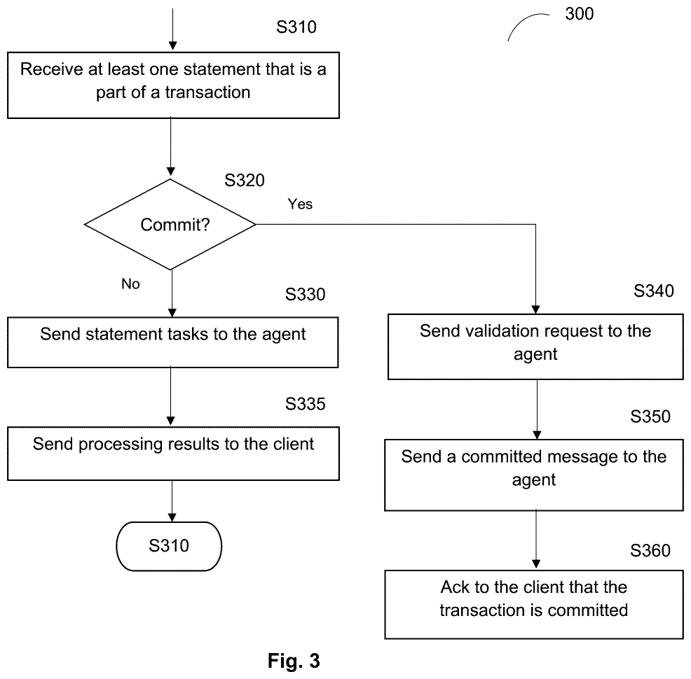

FIG. 3 shows an example flowchart 300 of a concurrency control protocol (CCP) for executing transactions in a non-distribute database according to an embodiment. The method can be performed by a transaction manager instantiated on the database's node, such as node 210, FIG. 2.

At S310, at least one statement that is part of a transaction initiated by a client is received. A transaction may include a collection of statements, each of which may include a collection of tasks. A task may require the execution of read operation(s), write operation(s), or both. A task may be a program or logic typically executed by an agent. A read operation requires reading data from a data cell, while a write operation requires writing data to a data cell. A statement may include a commit statement, thereby committing the transaction.

At S320, it is checked if a received statement is a commit statement, and if so, execution continues with S340; otherwise, execution continues with S330.

At S330, the tasks are sent to agent 215 to process the tasks that are part of a received statement. The tasks are performed by agent 215, configured to perform write and read operations. The execution of such operations by agent 215 during a working phase is discussed in greater detail below. It should be noted that S330 may be performed iteratively as part of the execution of one task when it is determined that another task is required. In some configurations, agent 215 maintains an indication whether at least one write operation was performed during the execution of the entire transaction.

At S335, at the end of the execution of all tasks associated with the received statement, a response is sent back to the client with the results of the processing of the statement. Then, execution returns to S310.

Execution reaches S340 when a commit statement is received from the client. At this stage, a validation request is sent to agent 215 if a write operation has been performed during the execution of the received transaction. It should be noted that if no write operation has been performed, there is no validation request, and execution continues with S350. In the CCP, the agent performing a validation will take a commit pause at the end of the validation process. The commit pause is taken to enable the atomicity of transaction commitment, by preventing race conditions between the committing transaction that completed its validation and other transactions that may then attempt to read data-cells that were modified by the committing transaction.

At S350, upon receiving validation confirmation messages from agent 215 that performed write operations on behalf of the transaction, a committed message is sent to agent 215 regardless of whether agent 215 performed write operations or not. A committed message indicates to agent 215 to commit the operations performed and to release the commit pause taken during the validation phase. At S360, an acknowledgment is sent to the client that the transaction is committed. It should be noted that S350 and S360 can be performed in parallel or in a different order.

As can be understood from the above description, the operation of a transaction manager carries through three phases: working, validation, and commit. In the working-phase, one or more statements of a transaction are processed. In the validation-phase, all data cells that have been written through the transaction are validated. In the commit-phase, the entire transaction is committed.

The method discussed with reference to FIG. 3 provides CCP implemented into a database system (or simply a database). Consistency of transactions, by means of the disclosed protocol, is achieved through isolating transactions and adopting different approaches during the execution phases of a transaction. Here, an optimistic approach is implemented during the working-phase of a transaction to allow the operation of multiple transactions to run independently without blocking or locks. For validation of a transaction, a pessimistic approach is taken, where a transaction may wait for other transaction(s) to commit. As a result, fewer transactions are aborted in comparison to a known implementation of an optimistic concurrency control protocol, thereby improving the overall performance of the databases. The detailed operation of the CCP as discussed in FIG. 3 includes the working-phase, validation-phase, and commit-phase are described in greater detail in the above-referenced Ser. No. 18/591,615 application.

The disclosed embodiments provide a predictive CCP, which allows, in some cases, the early commit of validating transactions. That is, in some cases, a validating writing transaction (hereinafter “validating-transaction TR1”) may progress to commitment even when it modified a data-cell, or multiple data-cells that were read by a reading transaction (hereinafter “reading-transaction TR101”) that has not yet committed.

According to the disclosed embodiments, same as the CCP discussed in FIG. 3, the working-phase of the predictive CCP is non-blocking. This is advantageous as locking mechanisms tend to result in slower speeds, greater expenses, and greater complexity.

In general, optimistic CCP approaches are non-blocking, but tend to abort transactions upon the detection of conflicts, and usually require the detection of read/write, write/write, and write/read conflicts. As opposed to conventional optimistic CCP approaches, the disclosed embodiments are more tolerant, as the predictive CCP requires only the detection of read/write conflicts. Further, the predictive CCP allows, under some cases, ignoring read/write conflicts that cannot be ignored by conventional optimistic CCP approaches.

Furthermore, according to the disclosed predictive CCP, even if the read/write conflict cannot be ignored, transactions that participate in such a conflict will generally not abort. Instead, in the disclosed protocol, dependencies among such transactions will alter the order of commitments. Any such blocking during validation-phase is done only after a validating transaction has already completed its working-phase and thereby released the resources that were required for its execution. In that respect, such a blocking would use meaningfully fewer resources than a blocking by a conventional CCP. Furthermore, in database environments, the realization of these dependencies is generally simple and consumes minimal resources.

It should be noted that as would also apply to conventional pessimistic and optimistic CCPs, the predictive CCP is not immune from inter-transaction deadlocks. In the case where an inter-transaction deadlock is detected, one transaction out of the deadlock cycle would be aborted. Techniques for handling deadlocks, including deadlock detection and deadlock prevention techniques, are beyond the scope of the present disclosure.

It should be further noted that the disclosed predictive CCP allows for the performance of a higher degree of parallelism in transaction execution relative to pessimistic solutions while maintaining the same state of the database at the end of processing such transactions as if the transactions were executed in serial. This allows for the fast execution of transactions and the processing of more transactions at a given time period. Therefore, the disclosed embodiments provide a technical improvement over current database systems that, in most cases, fail to serve applications that require fast and parallel execution of transactions for retrieval and modification of datasets. The disclosed predictive CCP can be implemented in database systems as well as in data management systems, such as an object storage system, a key-value storage system, a file-system, and the like.

As briefly mentioned above, in the predictive CCP, in some cases, a validating-transaction TR1 (i.e., a transaction that is in a validation-phase) that has modified a data-cell (or a set of data-cells) previously read by an existing reading-transaction TR101 may be enabled to commit even prior to the completion of reading-transaction TR101, while maintaining serializability and other expected consistency properties. This enablement improves the concurrency of the transaction execution. In contrast, it should be noted that in some CCPs disclosed in the related art, validating-transaction TR1 would always be dependent on reading-transaction TR101's completion and would not be able to commit prior to the completion of reading-transaction TR101.

It should be noted that the above-mentioned cases that allow such an earlier commitment have to do with cases where reading-transaction TR101 evaluated a predicate as part of its execution. As mentioned above, a predicate, as discussed in the related art, may be defined as a part of a transaction statement within a database that describes a condition upon which an action may commence. As a non-limiting example, a transaction enacted on a single row in a database may be colloquially described as the following directive: “If John's profession is a software engineer and John's start date is before Jan. 1, 2010, then increase John's salary by ten percent and update John's profession to senior software engineer.” For such a transaction, the predicates are the variables included in the “if” clause, namely “John's profession” and “John's start date”. In contrast, the actions are the steps taken in the “then” clause, namely the increase in John's salary and the update to John's profession.

It should be noted that, as previously discussed, predicates can also be used as part of a statement that selects one or multiple rows that satisfy a predicate. For example, in such a statement where the predicate data-cells are “profession” and “start date”, the predicate data-cell set may comprise “[Jane's profession, Jane's start_date]”, “[John's profession, John's start_date]”, and so on.

In an embodiment, reading-transaction TR101 may have read a relevant data-cell set as part of a predicate evaluation, where, after the predicate returned TRUE or FALSE, the actual concrete contents of the read data-cells that were used for the predicate evaluation are not further used by reading-transaction TR101. In such cases, if a validating-transaction TR1 modifies one or more of those predicate data-cells in a way that will not affect the result of the predicate, then, with some further conditions fulfilled, validating-transaction TR1 may consider itself not dependent on that specific reading-transaction TR101's predicate evaluation (and its associated reads). In this specific example, if no other dependencies of validating-transaction TR1 on reading-transaction TR101 are detected, validating-transaction TR1 may commit before reading-transaction TR101's commitment, i.e., validating-transaction TR1 is not dependent on reading-transaction TR101.

It should be noted that the improvement in commitment efficiency described above can be meaningfully beneficial. For example, in relational databases as well as other databases, there are direct ways to access specific cells of specific rows (e.g., by specifying a row ID, a primary index, etc.). However, there are (for example) SQL statements with a broader scope where such a statement acts upon a set of row(s) that are selected by evaluating a predicate. The table rows that satisfy the predicate are the ones that are affected by the statement. The predicate evaluation is either done by a full (data) scan, by index searches or by a combination of index searches and data scans.

From a general serializable CCP perspective (i.e., without the mechanisms described by this disclosure), such a predicate-based search (e.g., performed by a reading-transaction TR101) is generally analogous to reading all the predicate data-cells of all the rows in the table (e.g., of the entire columns related to the predicate), even if only some or even very few of the rows answer the predicate and are actually used by reading-transaction TR101. That may meaningfully limit the concurrency in transaction execution, as it may create many conflicts with other transactions. For example, a validating-transaction TR1 that modified pertinent data-cells in a couple of rows that were not selected by reading-transaction TR101 may, in many cases, be blocked due to reading-transaction TR101, despite the fact reading-transaction TR101 did not select these couple of rows. Therefore, the disclosed embodiments provide mechanisms that minimize such dependencies whenever possible.

The following discussion covers the different forms of the described predictive CCP. It is important to note that the examples used are for instructional purposes only.

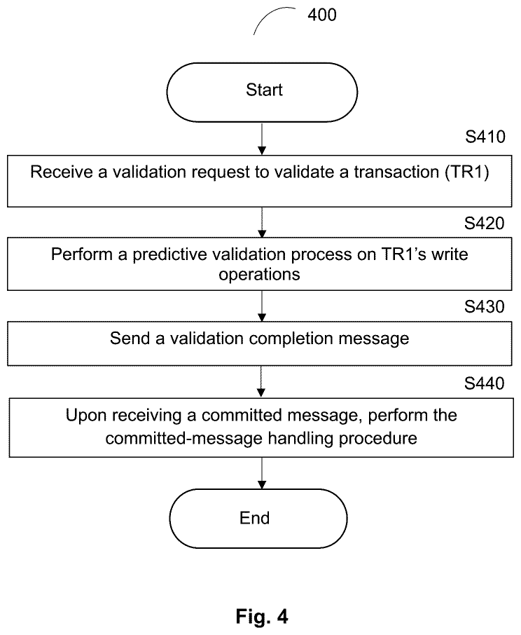

FIG. 4 shows an example flowchart 400 describing a process performed by an agent during a validation-phase of a transaction according to an embodiment. The validation-phase starts when the transaction manager receives a commit statement from the client that issued the transaction, validating-transaction TR1. The process includes checking what dependencies validating-transaction TR1 has on other existing reading transactions. The process further inspects whether validating-transaction TR1 can be enabled for an early-commit over a reading-transaction TR101 that evaluated one or more predicates that uses data-cells that validating-transaction TR1 modified. That is, the validating-transaction TR1 can commit before the completion of the reading-transaction TR101.

At S410, a validation request is received. In an embodiment, such a request is received by the agent that performed write operations on behalf of validating-transaction TR1. If the agent did not perform a write operation (for example, if TR1 is a read-only transaction), then process for TR1 will be initiated at S440, upon receiving a committed message from TR1's transaction manager.

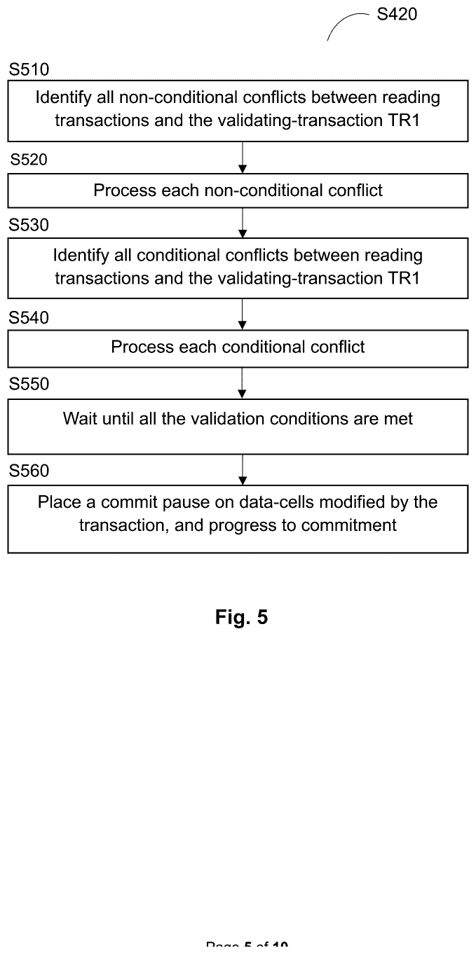

At S420, a validation process is performed. In some embodiments, the validation process is performed for all write operations executed by an agent on behalf of validating-transaction TR1. The various embodiments of S420 are further discussed in FIG. 5.

At S430, a validation completion message is issued. In an embodiment, such a message is sent to the transaction manager and issued by the agent performing the validation process. As noted above, when such messages are issued, commit pauses are taken to allow the transaction to commit.

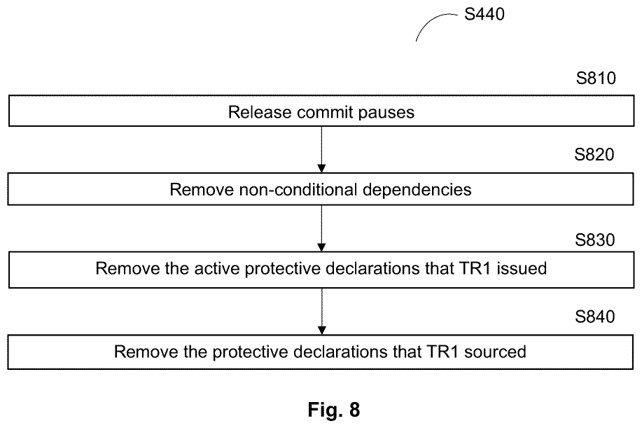

At S440, upon receiving a committed message, a committed-message handling procedure is performed. In one embodiment, during this procedure, commit pauses that the validating-transaction TR1 placed and all dependencies associated with the validating-transaction TR1 are released. Furthermore, when a transaction that wrote to data-cells commits, the contents of the data-cells become “committed” to override data currently stored in data-cells. The various embodiments of S440 are further discussed in FIG. 8.

FIG. 5 is an example flowchart of S420 describing the operation of a validation-phase of the predictive CCP according to one embodiment. The process S420 can be performed by an agent validating a validating-transaction TR1. Thus, process S420 is performed during the validation-phase of validating-transaction TR1 to check what dependencies a validating-transaction TR1 has on other existing reading-transactions. The working-phase and the commit-phase of the predictive CCP can be performed as discussed in reference to FIG. 3.

The process S420 further inspects whether the validating-transaction TR1 can be enabled for an early commit over a reading-transaction TR101 that evaluated a predicate(s) that uses data-cells that validating-transaction TR1 modified. Additionally, the process S420, according to some embodiments, includes protective validation techniques described in detail hereinafter.

A validation-phase is a process within a transaction, for example, validating-transaction TR1, whereby validating-transaction TR1 checks for whether at least one reading transaction has read any of the data-cells that were modified by validating-transaction TR1. A validation-phase may occur after a working-phase and may result in a block of validating-transaction TR1 until the commitment of a reading-transaction TR101) on which validating-transaction TR1 is determined to be dependent. According to the disclosed embodiments, the validation-phase may not always determine that validating-transaction TR1 depends on reading-transaction TR101 that has read data-cells that validating-transaction TR1 modified, and hence, in some cases, may allow validating-transaction TR1 to commit before reading-transaction TR101 has committed.

Typically, the process S420 is performed when a commit statement is received from the client. At this stage, a validation request is sent to an agent that has performed a write operation.

It should be noted that according to the disclosed embodiments, during a working-phase of a transaction (TR5), a read-vector (RV), and a write-vector (WV) are created. The RVs and WVs are updated and scanned during the working-phases and validation-phases to avoid situations of data conflicts. It should be noted that scanning the vectors is only one technique that can be used herein, for example, by means of lookup tables.

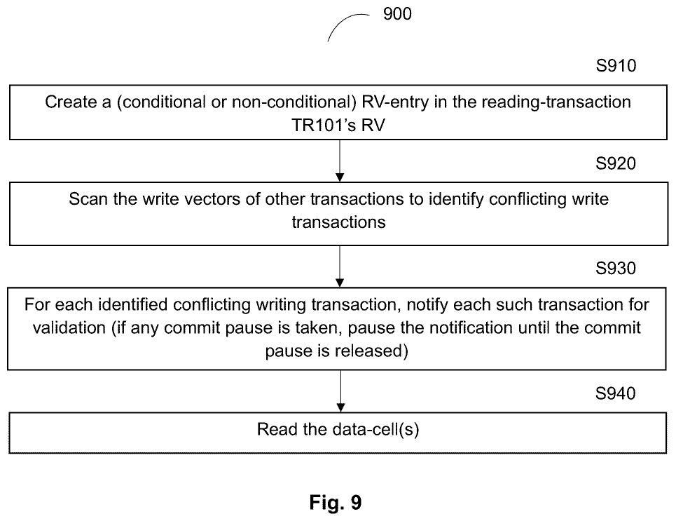

For example, during a working-phase of a transaction TR5, if TR5 reads a data-cell that is not for the purpose of a predicate evaluation (non-conditional read), TR5 may then add an RV-entry (non-conditional RV-entry) to its RV. This entry designates the data-cell being read. TR5 may then read the most up-to-date committed cell contents. The process for reading data cells according to the disclosed embodiments are discussed in FIG. 9.

In one embodiment, during a working-phase of TR5, if TR5 evaluates a predicate, the transaction TR5 may add an RV-entry (conditional RV-entry) to its RV. This entry designates the entire predicate evaluation, including information describing the predicate that is evaluated. A single conditional RV-entry may represent a predicate evaluation of a single data-cell set or of multiple data-cell sets. A predicate evaluation of multiple data-cell sets may occur, for example, if the scope of the predicate contains multiple rows or the entire set of rows of a table.

Then, according to an embodiment, TR5 may perform the predicate evaluation of one or more data-cell sets by reading their most up-to-date committed cell contents. Such data-cell read(s) may be denoted as a “conditional read”. During a working-phase of TR5, when TR5 writes a data-cell, TR5 may add a WV-entry to its WV, designating the data-cells being written. Additionally, TR5 writes the data-cell contents in an “uncommitted manner” such that they are “private” and hence inaccessible for reading by any other transaction. Such a data-cell write may not override or change any elements of the currently committed data-cell contents.

At S510, the current non-conditional conflicts with the validating-transaction TR1 and their related conflicting transactions are identified. In general, a conflict may be indicated by the presence of cells that were modified by the validating-transaction TR1 and were read by another existing reading-transaction TR101. A non-conditional conflict is defined as a conflict pertaining to a read operation by the reading-transaction TR101 that was not performed as part of a predicate evaluation. Such a reading-transaction may be denoted as a “conflicting transaction”. In an embodiment, all the current non-conditional conflicts with the validating transaction are identified. In one example embodiment, this identification includes iteratively scanning the WV of the validating-transaction TR1 for data cells that validating-transaction TR1 wrote to. Further, for each such data cell, all active reading transactions (except for validating-transaction TR1 itself) that read from the cell are identified. This can be performed by scanning the reading transactions' RVs. The RVs and WVs are maintained by an agent (e.g., agent 215).

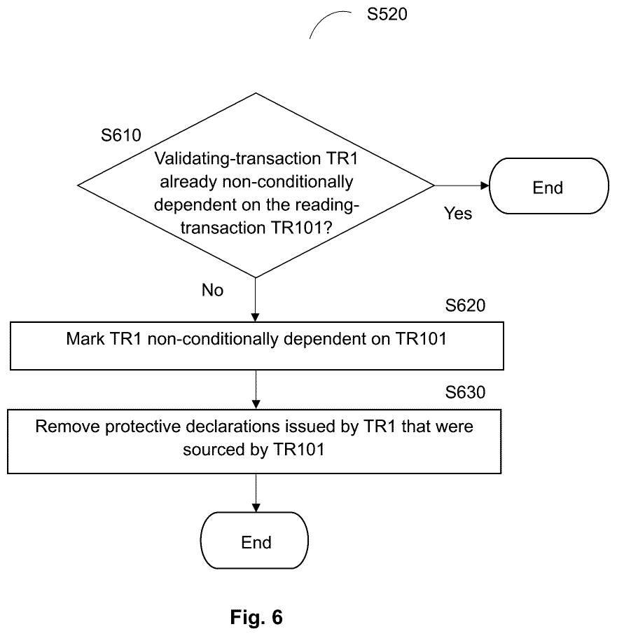

At S520, each identified non-conditional conflict is processed. In an embodiment, S520 includes marking the validating-transaction TR1 as dependent on each of the identified conflicting transactions. The dependencies can be maintained in a data structure, such as a graph, a table, and the like. It should be noted that if no non-conditional conflicts are identified, S520 is skipped. S520 is described in more detail with respect to FIG. 6.

At S530, the current conditional conflicts and their related conflicting transactions are identified. A conditional conflict is defined as a conflict pertaining to a read by a reading-transaction TR101 that was performed as part of and for the purpose of predicate evaluation of a specific data-cell set. In an embodiment, all the current conditional conflicts with the validating transaction are identified. A read that was performed as part and for the purpose of a predicate evaluation may be denoted as a conditional read and may include the creation of a conditional RV-entry. Such a reading-transaction may also be denoted as a “conflicting transaction”. In an embodiment, a conditional RV-entry represents the entire predicate evaluation.

It should be noted that a conditional conflict is in a data-cell set granularity. For example, a reading-transaction TR101 evaluates a predicate PR1010 for all the rows in a table. The predicate PR1010 is used to select the rows of people with red hair-color and a software-engineer profession. In this example, the validating-transaction TR1 modified Jane's hair-color and also modified George's hair-color.

In that example, there are two conditional conflicts between validating-transaction TR1 and reading-transaction TR101 both for predicate PR1010. One conditional conflict is for the data-cell set [Jane's hair-color, Jane's profession], and the other conditional conflict is for the data-cell set [George's hair-color, George's profession].

At S540, each identified conditional conflict is processed. In an embodiment, each identified conditional conflict may be classified as being of a particular state. A state characterizes a particular relationship between the evaluations of a predicate before and after the commitment of a validating transaction TR1. The process of determining the state of the conditional conflict is discussed further below. As discussed below, the state may include move-in, move-out, stay-in, or stay-out. In an embodiment, the determination of each of the four states requires the execution of the epsilon checking procedure as discussed below.

In general, a move-in state describes the following situation: R5 is the row containing the data-cell set related to the pertinent conditional conflict between reading-transaction TR101 and the validating writing-transaction TR1 related to predicate PR1010 evaluated by TR101; and TR1 is the only currently active transaction that modifies any of the data-cells related to that data-cell set.

In the move-in state, without the modifications TR1 applies, the evaluation of PR1010 will not select row R5. In the move-in state, with the modifications TR1 applies, the evaluation of PR1010 will select row R5. Therefore, to satisfy various transactional consistency expectations, an early commit of TR1 may require “moving R5 into” the set of rows selected by TR101. Since TR101's execution may not be able “to see” TR1's modifications, an early commitment of TR1 may violate the transactional consistency expectations and hence may not be allowed.

Similarly, in general, a move-out state describes a situation where, without TR1's modifications, TR101 will select R5, whereas if TR1's modifications were included, TR101 would not select R5. Therefore, similarly, TR1's early commitment may not be allowed.

In general, a stay-in state describes the situation where, under similar conditions as described above, TR101 would select R5, with or without including TR1's modifications. Therefore, it can be viewed as if the early commit of TR1 keeps R5 “stays in” the set of rows selected by TR101.

Similarly, a stay-out state describes the situation where TR101 would not select R5, with or without including TR1's modifications. Therefore, this state can be viewed as if the early commit of TR1 makes R5 “stays out” of the set of rows selected by TR101. Under some conditions, and from the perspective of this specific conditional conflict, TR1 may be allowed to commit earlier than TR101 for both stay-in and stay-out cases. This scenario is further discussed in the above-referenced Ser. No. 18/944,462 application.

In an embodiment, this evaluation may utilize an epsilon checking procedure (based on the epsilon principle explained herein). Given a validating-transaction TR1 that has a conditional conflict with a reading-transaction TR101, the epsilon checking procedure determines whether a state of a conditional conflict is a stay-in, stay-out, move-in, or move-out state. The epsilon checking procedure relates to two methods of characterizing the moments immediately before and immediately after a transaction commitment. The function ε−(TR1) may be denoted to describe the moment immediately prior to the commitment of transaction TR1, while the function ε+(TR1) may be denoted to describe the moment immediately following the commitment of validating-transaction TR1.

In an embodiment, by epsilon checking procedure, an evaluation of a predicate of a transaction may be denoted in relation to a specific timepoint for a specific row. For example, fora predicate PR1010, a function PR1010(x, ε+(TR1)) will return the evaluation of PR1010 for the pertinent data-cell set of row ‘x’ at the moment immediately following the commitment of a validating-transaction TR1. According to an example embodiment, a validating-transaction TR1 is initiated after a reading-transaction TR101 is initiated, but before reading-transaction TR101 is committed. TR101 involves the evaluation of a predicate PR1010, and validating-transaction TR1 is validating. In this example, the epsilon principle allows for TR1 to commit before the commitment of TR101 if PR1010(x, ε+(TR1))=PR1010(x, ε−(TR1)). Therefore, if the evaluation of PR1010 at row ‘x’ returns the same values immediately prior to validating-transaction TR1's commitment as immediately following validating-transaction TR1's commitment, validating-transaction TR1 may be allowed to commit before the commitment of reading-transaction TR101. The result is denoted that the “epsilon principle is satisfied”. It should be noted that in a plurality of embodiments, there may be more than one predicate that would need to satisfy the epsilon principle in order to allow for a validating-transaction TR1 to commit early.

It should be noted that for the PR1010(x, ε−(TR1)) function calculation, the values to be evaluated by the predicate function are those that are currently committed. For the PR1010(x, ε+(TR1)) function calculation, the values to be evaluated by the predicate, for data cells that were not modified by TR1, are those that are currently committed. In addition, for data cells that were modified by TR1 the values to be evaluated by the predicate are those written by TR1. This scenario is further discussed in the above-referenced Ser. No. 18/944,462 application.

For brevity and clarity, the combination of a predicate (e.g., PR1010) and a data-cell set (e.g., a specific row R5) it evaluates will be notated as “[PR1010*R5]”. It should be noted that a conditional conflict between validating writing-transaction TR1 and reading-transaction TR101 on behalf of predicate PR1010 and row 5 may be denoted as a conditional conflict related to [PR1010*R5]. Additionally, in an embodiment, the predicate evaluates multiple rows of a table. As each data-cell set represents data-cells that belong to the same row, the identity of a row (e.g., row R5) and the corresponding data-cell set evaluated by the predicate (e.g., DCS5) will be used interchangeably to denote the associated data-cell set.

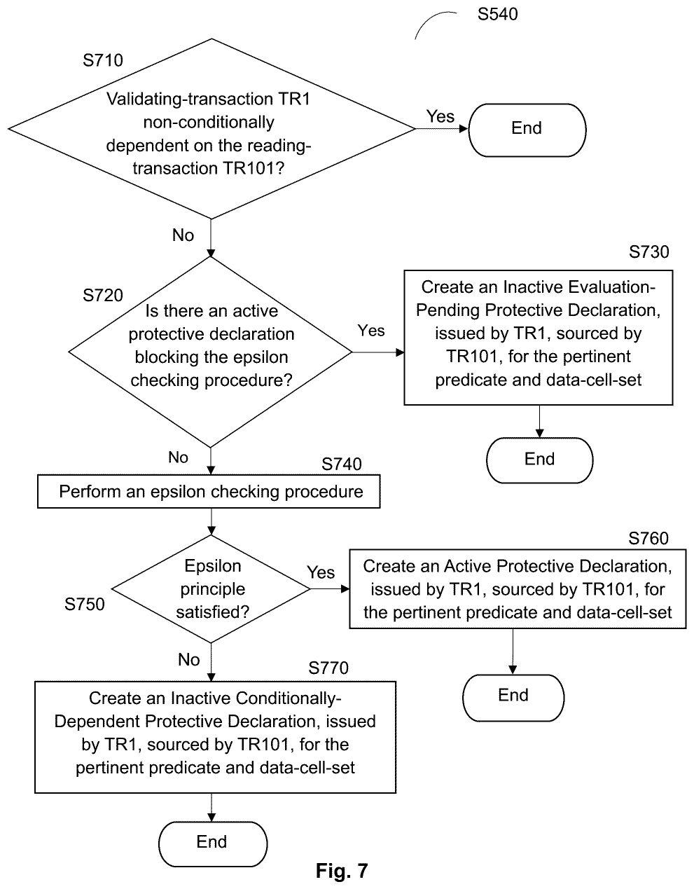

In some embodiments, if the epsilon principle is satisfied, an active protective declaration will be issued by the validating-transaction TR1, sourced by the reading-transaction TR101, for a specific predicate of a data-cell set where the epsilon principle is satisfied (e.g., for [PR1010*DCS1]. An active protective declaration is a mechanism that prevents other writing transactions that modified the contents of that data-cell set from committing. That is, as long as that active protective declaration exists, no other writing transaction (e.g., TR2), if any, that modified any of DCS1's cells, will be able to commit and/or to evaluate the epsilon principle for [PR1010*DCS1]. Such a declaration functions to ensure the contents of a data cell in which the epsilon principle is satisfied are not modified by another transaction such that the epsilon principle is not satisfied. Generally, a protective declaration is associated with a conditional conflict between a validating writing-transaction TR1 and a reading-transaction TR101. Such a protective declaration is denoted as “issued” by the validating writing-transaction TR1 and is denoted as “sourced” by the reading-transaction TR101. A protective declaration may have inactive states wherein the protective declaration exists for a specific predicate of a data-cell set but does not have the protective effect as described above. Such a state may be changed from inactive to active or active to inactive in various embodiments. It should be noted that if no conditional conflicts are identified, S540 is skipped. The operation of S540 is described in more detail with respect to FIG. 7.

At S550, it is determined whether the validating-transaction TR1 can commit. This may include checking various conditions. That is, the validating-transaction TR1 is instructed to wait until validation conditions are satisfied. The validation conditions include: (1) validating-transaction TR1 is neither conditionally nor non-conditionally dependent on any reading-transaction (conditional and non-conditional dependencies are described in further detail hereinafter); (2) all non-conditional conflicts were processed at S520, and all conditional conflicts were processed at S540; (3) the validating-transaction TR1 does not have any evaluation-pending validations or evaluation-deferred validations; and (4) any active protective declarations issued by validating-transaction TR1 are not part of a challenging process (discussed in detail later). If the validation conditions are met, execution continues to S560.

Execution reaches S560 when the validating-transaction TR1 can commit. To this end, S560 includes placing a commit pause on data cells modified by the validating-transaction TR1. Placing the commit pause allows the transaction to progress to the commit-phase. It should be noted that, in an embodiment, standard means of avoiding race-conditions are assumed. In an example embodiment, the placement of commit pause at S560 is achieved atomically with the conclusion that all validation conditions are met at S550.

It should be noted that in an embodiment, the commitment process for the validating-transaction TR1 may be paused for as long as the reading transactions it depends on do not complete their execution, that is, until those reading transactions commit or abort. For example, the determination that a conditional conflict is in a move-in state will lead to a dependency of the validating-transaction TR1 on the corresponding reading-transaction. This pause is initiated in order to preserve concurrency control and prevent the committed values of the validating-transaction TR1 from compromising data integrity.

Although FIG. 5 shows example blocks of process S420, in some implementations, process S420 may include additional blocks, fewer blocks, different blocks, or differently arranged blocks than those depicted in FIG. 5. In an embodiment, conditional and non-conditional conflict identification and processing can be performed in any order. In an example embodiment, a conditional conflict may be identified and processed before a non-conditional conflict.

FIG. 6 is an example flowchart S520 showing a process for processing a non-conditional conflict according to an embodiment. The process is performed for each identified non-conditional conflict. The validating-transaction is TR1 and the non-conditional conflict is with reading-transaction TR101.

At S610, it is determined whether the validating-transaction TR1 is already non-conditionally dependent on the reading-transaction TR101. If so, execution ends. Otherwise, execution continues with S620.

At S620, validating-transaction TR1 is marked as non-conditionally dependent on the reading-transaction TR101, reflected in, for example, a transaction commitment dependency graph.

At S630, any protective declarations that were issued by the validating-transaction TR1 that were sourced by reading-transaction TR101 are removed. It should be noted that such a protective declaration can exist if, for example, the validating-transaction TR1 previously validated a conditional conflicting RV-entry of the reading-transaction TR101 related to another data-cell that validating-transaction TR1 modified (or even related to the same data-cell that validating-transaction TR1 currently validates), in the context of a predicate TR101 evaluates. It should be noted that as the validating-transaction TR1 is marked as non-conditionally dependent on reading-transaction TR101, the predictive CCP does not pursue any attempt for committing validating-transaction TR1 earlier than reading-transaction TR101. Therefore, means such as those protective declarations (issued by validating-transaction TR1 and sourced by reading-transaction TR101) are no longer relevant and, hence, are removed.

In one embodiment, if such a removed protective declaration is an active protective declaration, this act may have a “chain reaction”, as there may be another validating-transaction TR2 (or even multiple validating-transactions) that is “interested” in performing an epsilon checking procedure for the corresponding predicate and data-cell set. Transaction TR2 cannot perform that checking procedure as it was blocked by the above active protective declaration issued by validating-transaction TR1. As a result of the removal, validating-transaction TR2 will no longer be blocked, and can now perform the epsilon checking procedure. In an embodiment, if there are multiple “interested” transactions, the epsilon checking procedures can be performed only once at a time.

In the case that a previous conditional-conflict validation of the validating-transaction TR1 for a conditional-conflict with reading-transaction TR101 (for another modified data-cell or for the currently validated data-cell) is blocked by an active protective declaration made by another transaction (e.g., TR2), then validating-transaction TR1 may continue such a blocked validation once the protective declaration is no longer active. However, since validating-transaction TR1 is now non-conditionally dependent on reading-transaction TR101, there is no need to further pursue any attempt for committing earlier than reading-transaction TR101. Therefore, the blocked validation of TR1 is no longer relevant and can be canceled. Similarly, if a previous such conditional-conflict validation is deferred, that deferred validation is no longer relevant and can be cancelled.

It should be noted that process S520 is iteratively performed for each non-conditional conflict identified at S510 (FIG. 5).

FIG. 7 is an example flowchart S540 showing a process for processing a conditional conflict according to an embodiment. The process is performed for each identified conditional conflict. The validating-transaction is TR1 and the non-conditional conflict [PR1010*DCS1] is with reading-transaction TR101. That is, for TR101's evaluation of predicate PR1010 for data-cell-set DCS1. As already mentioned, in an embodiment, the data-cell set represents a specific row evaluated by the predicate.

At S710, it is determined whether the validating-transaction TR1 is already non-conditionally dependent on the reading-transaction TR101. If so, execution ends. Otherwise, execution continues with S720.

At S720, for the identified conditional conflict, it is determined whether there is already an active protective declaration, issued by another validating-transaction (e.g., TR2), sourced by TR101, for [PR1010*DCS1] that prevents the validating-transaction TR1 from performing the epsilon checking procedure. If S720 results in a Yes answer, execution proceeds to S730; otherwise, execution continues with S740.

At S730, an inactive evaluation-pending protective declaration is issued by validating-transaction TR1 and sourced by reading-transaction TR101. The protective declaration is issued for the pertinent predicate and data-cell set [PR1010*DCS1]. An inactive evaluation-pending protective declaration is a protective declaration as defined above but, unlike active protective declarations, its existence does not block other validating-transactions. It is used to mark that TR1 may still need to perform the pertinent epsilon check for [PR1010*DCS1].

It should be noted that, according to an embodiment, if the currently active protective declaration issued by another validating-transaction (e.g., TR2) that blocked the epsilon checking of TR1 is later inactivated and/or removed, then the transactions whose epsilon checking procedures are pending (represented by their inactive evaluation-pending protective declarations) may proceed to perform their epsilon checking procedures. In the case that there are multiple transactions that are waiting to perform the epsilon checking procedure for that specific predicate and data-cell set, that epsilon checking procedures are not performed simultaneously, but one transaction after the other. When TR1, having the inactive evaluation-pending protective declaration on [PR1010*DCS1] is enabled for an epsilon checking procedure as described above, its corresponding inactive evaluation-pending protective declaration may be removed. As discussed later in more detail, if the epsilon principle is satisfied for that epsilon check, TR1 issues an active protective declaration, sourced by TR101, on [PR1010*DCS1]. In such a case, if there are additional validating-transactions waiting to perform the epsilon checking procedure for [PR1010*DCS1] such transactions will be blocked again, this time by the active protective declaration that was just issued by TR1.

After execution at S730 completes, the process discussed in FIG. 7 may conclude, and the validation process may proceed to identify other conflicts. It should be noted that any such inactive evaluation-pending conflict should be resolved before validating-transaction TR1 can continue to its commitment. In one embodiment, if the above inactive evaluation-pending protective declaration issued by validating-transaction TR1 still exists once reading-transaction TR101 commits, then the declaration is removed, and the validation is no longer relevant. This is disclosed in further detail hereinafter.

At S740, an epsilon checking procedure is performed on the specific conditional conflict with reading-transaction TR101. That is, given a validating-transaction TR1 that has a conditional conflict with a reading-transaction TR101 for [PR1010*DCS1], the epsilon checking procedure determines the state of the conditional conflict, e.g., stay-in, stay-out, move-in, or move-out state. The epsilon checking procedure operates as explained above with respect to FIG. 5.

It should be noted that, according to some embodiments, the epsilon checking procedure is not performed or is deferred according to various considerations including but not limited to the following: whether all or some of the data is not in cache memory, the length of time of execution of a transaction, the computational demand of evaluating a predicate, etc. Additionally, the decision not to perform an epsilon checking procedure for [PR1010*DCS1] by TR1 may be reversible or irreversible, according to various embodiments. In an embodiment, if the decision is irreversible, the specific conditional conflict is transformed to be a non-conditional conflict. The steps described in FIG. 6 are taken, such as marking TR1 as non-conditionally dependent on TR101, removing any protective declarations issued by TR1 and sourced by TR101, and so forth. As a result, TR1 will not be able to commit earlier than TR101. Then, the process discussed in FIG. 7 may conclude, and the validation process may proceed to identify other conflicts.

In an embodiment, a reversible decision for not performing an epsilon checking may be taken in a reversible manner. That is, the epsilon check is deferred, such that an opposite decision to perform the specific epsilon checking could be taken later (in an example embodiment, the decision can be re-evaluated in half a second). An inactive evaluation-deferred protective declaration is issued by validating-transaction TR1, sourced by reading-transaction TR101, for [PR1010*DCS1]. Then, the process discussed in FIG. 7 may conclude, and the validation process may proceed to identify other conflicts. Similar to the inactive evaluation-pending protective declaration, the existence of an inactive evaluation-deferred protective declaration does not block other validating-transactions. It is used to mark that TR1 may still need to perform the pertinent epsilon check for [PR1010*DCS1], in case the decision not to perform the epsilon check will be reversed. If that decision is reversed, the corresponding inactive evaluation-deferred protective declaration may be removed. The steps described in FIG. 7 may then be re-taken. It should be noted that any such inactive evaluation-deferred conflict should be resolved before validating-transaction TR1 can continue to its commitment. In an embodiment, if the decision not to perform the epsilon check is not reversed, then once TR101 commits, the inactive evaluation-deferred protective declaration discussed above is removed, and the validation is no longer relevant. This is disclosed in further detail hereinafter.

At S750, it is determined if the epsilon principle is satisfied. In an embodiment, the epsilon principle is satisfied when the epsilon checking procedure classifies the conditional conflict's state as either stay-in or stay-out and is not satisfied when the conflict's state is move-in or move-out. If S750 results in a YES answer, execution continues with S760; otherwise, execution continues with S770.

At S760, an active protective declaration, sourced by reading-transaction TR101, for the predicate and data-cell set [PR1010*DCS1] is issued by TR1. This active protective declaration ensures that the data-cell set for which the epsilon checking procedure resulted in the epsilon principle being satisfied is not modified until validating-transaction TR1's commitment. In this case, validating-transaction TR1 is denoted as “conditionally independent” of reading-transaction TR101 for the specific predicate for the specific data-cell set [PR1010*DCS1]. It should be noted that when and if the active protective declaration becomes inactive and/or is removed prior to validating-transaction TR1's commitment, the results of the epsilon checking procedure may become invalid at the moment of such an event. It should be noted that, in an embodiment, standard means of avoiding race-conditions are assumed. In an example embodiment, the epsilon checking procedure and the issuance of the active protective declaration are achieved atomically with each other.

At S770, an inactive conditionally-dependent protective declaration for a predicate and data-cell set [PR1010*DCS1] is issued. In some embodiments, the inactive conditionally-dependent declaration is issued by validating-transaction TR1 and sourced by reading-transaction TR101. This occurs because the epsilon principle is not satisfied for that predicate. Validating-transaction TR1 is said to be “conditionally dependent” on reading-transaction TR101. The issuance of an inactive conditionally-dependent protective declaration allows validating-transaction TR1 to perform the epsilon checking procedure again for that predicate and data-cell set [PR1010*DCS1] in the case where another validating-transaction (e.g., TR2) modifies one (or more) of the pertinent data-cells and commits. The re-evaluation as part of the epsilon checking procedure may result in satisfaction of the epsilon principle, and validating-transaction TR1 may thus be able to commit earlier than reading-transaction TR101.

It should be noted that, in an embodiment, if the epsilon checking procedure results in an unsatisfied epsilon principle, then, instead of making validating-transaction TR1 conditionally dependent on reading-transaction TR101, the specific conditional conflict may be transformed to be a non-conditional conflict. The process described in FIG. 6 is taken, such as marking TR1 as non-conditionally dependent on TR101, removing any protective declarations issued by TR1 and sourced by TR101, and so forth. As a result, TR1 will not be able to commit earlier than TR101. Then, the process discussed in FIG. 7 may conclude, and the validation process may proceed to identify other conflicts.

FIG. 8 is an example flowchart S440 illustrating the operation of committed-message handling procedure. In an embodiment, the procedure S440 is initiated when the transaction agent receives a committed message. The procedure is performed by the transaction agent when the transaction TR1 commits. It should be noted that, prior to its commitment, TR1 was a validating-transaction. In some embodiments, transaction TR1 cannot commit and needs to abort. In an embodiment, the process described herein is also applicable when TR1 aborts.

At S810, all commit pauses placed by transaction TR1 are released. Furthermore, when a transaction that wrote to data cells commits, the contents of the data cells become “committed” to override data currently stored in data cells. In an embodiment, the data-cells may become “committed” prior to the release of the commit pauses. It should be noted that the commit pauses that are released are only the commit pauses that the transaction TR1 placed, even if there are multiple commit pauses taken on the same data-cell. For example, if a commit pause was placed by transaction TR1 on data cell DC1 and another validating-transaction TR2 placed a commit pause on DC1, the commit pause of transaction TR1 on DC1 will be released, but the commit pause of validating-transaction TR2 on DC1 will not be released at that time.

At S820, non-conditional dependencies are removed. In an embodiment, the non-conditional dependencies that are removed are only the non-conditional dependencies of other validating-transactions on transaction TR1. For example, if validating-transaction TR2 is non-conditionally dependent on transaction TR1, the non-conditional dependency will be removed at this step as designated, for example, in a transaction commitment dependency graph.

At S830, all the active protective declarations that transaction TR1 issued are removed. In some embodiments, all such active protective declarations are removed by, for example, a transaction agent. As a result of the removal of the active protective declarations that transaction TR1 issued, in further embodiments, validating transactions that were previously blocked from validating a specific data-cell set (as it was protected by an active protective declaration that TR1 issued), including those having an inactive evaluation-pending protective declaration or an inactive conditionally-dependent protective declaration, may progress with their respective validations.

In some embodiments, these validations do not take place simultaneously but execute one after the other. According to this embodiment, the order of execution of previously blocked validating transactions mentioned above are determined according to a variety of strategies. In other embodiments, these validations may be executed simultaneously.

At S840, all protective declarations (whether active or inactive) that transaction TR1 sourced are removed. In some embodiments, this removal is performed by a transaction agent. This step deals with the case where validating-transaction TR2 is a transaction that issued a protective declaration (e.g., PD2) for a predicate and a data-cell set [PR1*DCS1] that transaction TR1 sourced, and PD2 still exists.

In one embodiment, validating-transaction TR2 issued PD2 as an active protective declaration. PD2 is clearly not required anymore, as TR2 need not do any validation against TR1 as it already committed. Once PD2 is removed, there may be other transactions (e.g., TR3, TR4) that are waiting to progress to validation on [PR1*DCS1] as described hereinbefore. Such other validations may not be required and may be canceled during the execution of S840. In some embodiments, no other protective declarations for [PR1*DCS1] are issued because they are removed at this step.

In another embodiment, validating-transaction TR2 issued PD2 as an inactive conditionally-dependent protective declaration, wherein TR2 is conditionally dependent on transaction TR1, in the context of [PR1*DCS1]. PD2 is sourced by TR1. Since TR1 has committed, validating-transaction TR2 is no longer dependent on TR1. Therefore, PD2 can be removed. As a result, validating-transaction TR2 may progress to commitment, subject to further conditions, such as the ones described in step S550.

In another embodiment, validating-transaction TR2 issued PD2 as an evaluation-pending or evaluation-deferred protective declaration. Since TR1 has committed, validating-transaction TR2 is no longer dependent on TR1 and hence need not perform any related validation in the context of [PR1*DCS1]. Therefore, PD2 can be removed. As a result, validating-transaction TR2 may progress to commitment, subject to further conditions, such as the ones described in step S550.

FIG. 9 is an example flowchart 900 illustrating a process for reading data cells according to various embodiments.

At S910, a non-conditional and/or conditional RV-entry is added to the reading-transaction TR101's RV. In an embodiment, the addition of such RV-entries is performed by the reading-transaction TR101. In one embodiment, a non-conditional RV-entry is added for intended data cells reads that are not part of a predicate evaluation. As described hereinbefore, this non-conditional RV-entry designates the data-cells that are to be read. In another embodiment, a conditional RV-entry is added for data cells that are about to be read as part of a predicate evaluation. As described hereinbefore, this conditional RV-entry designates the entire predicate evaluation, including information describing the predicate that is evaluated. A single conditional RV-entry may represent a predicate evaluation of a single data-cell set or of multiple data-cell sets. That is, a conditional RV-entry may describe a set of cells that belong to the same row and/or a set of cells that belong to the same columns of a set of rows. A predicate evaluation of multiple data-cell sets may occur, for example, if the scope of the predicate contains multiple rows or the entire set of rows of a table.

It should be noted that, in another embodiment, a non-conditional RV-entry may be added for data cells that are about to be read as part of a predicate evaluation, instead of the creation of a corresponding conditional RV-entry. In case of related conflict with a validating writing-transaction, that conflict would then be a non-conditional conflict. In some embodiments, a non-conditional RV entry may describe a set of cells that belong to the same row and/or a set of cells that belong to the same columns of a set of rows. This may, for example, serve to reduce the resources involved in a decision to treat a predicate as a non-conditional RV-entry.

At S920, all existing writing transactions that already completed their working-phases and that modified data-cell(s) that reading-transaction TR101 reads and are represented by the RV-entry added at S910 are identified (hereafter denoted as “conflicting transaction”). For example, such identification may include scanning the WV-entries of writing-transactions that conflict with the RV-entry to identify writing-transactions that may be concluded to be conflicting with the reading-transaction TR101. In an embodiment, this scanning of the WV-entries of transactions is performed by the reading-transaction TR101.

At S930, for each such identified conflicting validating-transaction TR1, validating-transaction TR1 is notified about the addition of the non-conditional and/or conditional RV-entry that effectively represents a conflict between the validating-transaction TR1 and the reading-transaction TR101. In an embodiment, reading-transaction TR101 notifies validating-transaction TR1 so that validating-transaction TR1 can perform the validation. In some embodiments, reading-transaction TR101 actually performs validation acts for validating-transaction TR1. By the time reading-transaction TR101 adds the RV-entry and/or performs its related read(s), validating-transaction TR1 may already be in its validation-phase. This disclosed embodiment ensures that validating-transaction TR1 does not ignore the validation for that conflicting write transaction, which serves to ensure the correctness of the predictive CCP.

In an embodiment, if reading-transaction TR101 notifies validating-transaction TR1 about the addition of a non-conditional RV-entry, the process disclosed above and in FIG. 6 may be initiated. In an embodiment, such an initiated process may continue to execute asynchronously. In an embodiment, if TR1 has already processed the corresponding conflict, the notification may be ignored.

In an embodiment, if reading-transaction TR101 notifies validating-transaction TR1 about the addition of a conditional RV-entry, the process disclosed above and in FIG. 7 may be initiated. In an embodiment, such an initiated process may continue to execute asynchronously. In an embodiment, if TR1 already processed the corresponding conflict, the notification may be ignored.

In an embodiment, if validating-transaction TR1 holds a commit pause on the data-cells that validating-transaction TR1 modified and are related to the data-cells whose intended reading is represented by TR101's notification, then reading-transaction TR101's notification to validating-transaction TR1 may be delayed until the related commit pause(s) is released. In an embodiment, the process will not progress to S940 until that notification takes place.

In some embodiments, if validating-transaction TR1's validation-phase has not yet processed the pertinent conflict, validating-transaction TR1 may ignore the notification from reading-transaction TR101, and the validation may be performed later.

At S940, the data-cell(s) are read. In some embodiments, the reading-transaction TR101 performs the read.

It should be noted that in order for the early commitment of the validating-transaction to satisfy concurrency control requirements, the evaluation of the predicate of a reading-transaction TR101 should follow a set of conditions. The set of conditions may be denoted as the single predicate evaluation consistency principle. It should be further noted that the above disclosed embodiments with respect to the process of FIG. 9 function according to the predicate evaluation consistency principle. In an embodiment, the predicate evaluation consistency principle applies when a predicate that is evaluated as part of a statement execution is evaluated for one or more data cell sets where each data cell set may contain one or more data cells. According to this principle, the following conditions hold for each separate predicate evaluation of a specific data cell set. First, for each such predicate evaluation of a single data cell set, the data that is read to evaluate the predicate belongs to the same set of database data cells as the set that exists at a single specific point in time that is denoted as the virtual read timepoint. That is, if, for example, a predicate data-cell set contains two data-cells, [Jane's profession and Jane's hair-color], then the read contents of the two data-cells must be the committed contents of those data-cells for the very same point in time, namely the virtual read timepoint. However, it should be noted that if the predicate evaluates multiple data-cell sets, then the virtual read timepoint of each data-cell set may be different. Second, the virtual read timepoint is at a later time than the time the conditional RV-entry was added to a reading-transaction TR101's RV. That also means that the reading-transaction TR101 adds the corresponding conditional RV-entry to its RV before it performs any related reads that are required for the predicate evaluation. Third, the virtual read timepoint is at an earlier time than the time of usage of the predicate evaluation results.

In an embodiment, reading-transaction TR101 can perform predicate-evaluation in compliance with the predicate evaluation consistency principle by performing the predicate evaluations for each of the data-cell sets (e.g., for each of the rows) after the corresponding conditional RV-entry was added, where the reading of each data-cell set should be done atomically. It should be noted that different data-cell sets need not be read atomically with each other.

It should be noted that there may be cases where reading multiple data-cells of the same data-cell set (e.g., DCS1), for the sake of a predicate evaluation, cannot be achieved atomically, e.g., because those read operations cannot be done close enough to each other in time, thus making it too expensive or impossible to ensure atomicity of these operations. In an embodiment where reading a single data-cell is easily achieved in an atomic manner, the above-mentioned difficulty is mainly relevant for a multi-cell predicate, that is, a predicate with a data-cell set containing two or more data-cells. The following paragraph illustrates an example of this problem, and the subsequent paragraphs illustrate various embodiments that enable atomicity of transactions and ensure the single predicate evaluation consistency principle is adhered to.

In an example embodiment, in a relational database, a predicate uses a data-cell set of two data-cells. For example, the predicate searches for all employees in an employee table with a red hair-color and a profession of a carpenter. These two columns (hair-color and profession) are indexed. In the case that the expected population (i.e., selected rows) of the predicate is a small fraction of the table that they are in, a query planning optimizer may choose to calculate that predicate by performing two index searches and then intersect the two resulting row IDs (assuming the index value is the row ID). Through this approach, two data cells of a data-cell set DCS1 (that is, for example, one of the rows that predicate evaluates) are read completely separately as two separate search operations in two separate indexes that are each ordered differently. Therefore, the two data cells will not be read at more-or-less the same time, and therefore it will be hard and/or expensive to read them both atomically.

In one embodiment of the present disclosure, Point-in-Time (PiT) Imaging is used to address this problem. A PiT is an image of contents of a data-cell at a specific time (which is after the conditional RV-entry is added). A task in a database performs a PiT read when, as long as the specific PiT is created and exists, it reads a row-version for that point in time even though the database's execution progresses. In an embodiment, a PiT may be created by a reading-transaction TR101 after the RV-entry is created. The results of the PiT reads are used for the predicate evaluation. In some embodiments, a single PiT is used for all the data-cell sets evaluated by the predicate. In other embodiments, multiple PiTs are used, as long as all the data-cells of the same data-cell set are read from the very same PiT. In some embodiments, a PiT is used only for some of the data-cell sets, where the predicate evaluation for other data-cell sets is achieved differently.

In another embodiment, an ad hoc PiT is used. According to this embodiment, PiTs are created for the columns (and/or the indexes) that are part of a predicate evaluation. Just before the predicate evaluation begins, whenever a modification is made to the contents of a data-cell that is involved in the predicate evaluation, the older content is copied aside and used for the predicate evaluation. Once the predicate evaluation is over, the “previous versions” kept aside are erased. Such an embodiment may be more efficient than a more generic PiT usage, and therefore may be adequate also for databases that already support generic PiT usage.

In yet another embodiment, predicate decomposition is used. According to this embodiment, multi-cell predicates are decomposed into predicate 1 and predicate 2 and two separate RV-entries are added to reading-transaction TR101's RV for each predicate. As such, the predicate evaluation consistency principle will be effective on each of those predicates, separately.

Furthermore, the following paragraphs illustrate scenarios wherein a “challenging” process, according to various embodiments, is used.

In some embodiments, the following scenario is addressed: a validating-transaction TR1 issues an active protective declaration for a predicate of a data-cell set [PR1010*DCS1] sourced by a reading-transaction TR101, validating-transaction TR1 becomes dependent on another reading-transaction TR102 (or, in some other cases, conditionally-dependent on TR101 on behalf of a different conflict), and there are reasons to believe that this dependency will remain for a sufficiently long time before validating-transaction TR1 could progress to commitment. In this scenario, as well as others, another validating-transaction TR2 may be prevented from validating because of TR1's active protective declaration on [PR1010*DCS1], which, under some circumstances, may block TR2 from immediately early committing, such that it might hinder overall concurrency of the predictive CCP.

In one embodiment, validating-transaction TR2 may challenge that active protective declaration. In some embodiments, this challenging process involves the following steps.

First, a request to challenge the active protective declaration is sent to validating-transaction TR1. That is, a request to get a chance to “take over” [PR1010*DCS1], in case the epsilon check of TR2 will satisfy the epsilon principle. If the epsilon principle is not satisfied, TR1 will continue to own the active protective declaration on [PR1010*DCS1]. In an embodiment, this request is sent by validating-transaction TR2. It is determined, depending on various factors discussed in more detail below, whether TR1 will “agree” to accept that challenge. It should be noted that if TR1 has already progressed to commitment, then it cannot accept the challenge.

If validating-transaction TR1 accepts the challenge, then validating-transaction TR2 performs the epsilon checking procedure for the predicate of the data-cell set [PR1010*DCS1] that has the active protective declaration. In one embodiment, this is performed while the predicate of the data-cell set is still under the active protective declaration issued by TR1. During this step, validating-transaction TR1 is prevented from progressing to commitment.

In one embodiment, if TR2's epsilon checking procedure calculates that the epsilon principle is satisfied, then validating-transaction TR2 issues its own active protective declaration for that predicate of the data-cell set. As such, validating-transaction TR1 changes the state of its protective declaration to an inactive evaluation-pending protective declaration.

In another embodiment, if validating-transaction TR2's epsilon checking procedure calculates that the epsilon principle is not satisfied, then the active protective declaration for the predicate of the data-cell set issued by validating-transaction TR1 remains, and validating-transaction TR1 is not prevented (by that challenge processing) from progressing to commitment. Also, in a further embodiment, validating-transaction TR2 issues a protective declaration for the predicate of the data-cell set with an inactive state, e.g., inactive evaluation-pending protective declaration.

If validating-transaction TR1 does not agree to accept the challenge, then the active protective declaration for the predicate of the data-cell set [PR1010*DCS1] that validating-transaction TR1 issued remains, and validating-transaction TR1 is not prevented (by that challenge processing) from progressing to commitment. Also, in a further embodiment, TR2 issues a protective declaration for the predicate of the data-cell set [PR1010*DCS1] with an inactive state e.g., inactive evaluation-pending protective declaration.

According to the disclosed embodiments, validating-transaction TR1's determination of whether to accept the challenge on the active protective declaration that validating-transaction TR1 issued depends on a variety of conditions, including, but not limited to, the following: (1) how long validating-transaction TR1 holds the active protective declaration, (2) whether validating-transaction TR1 completed its validation-phase, (3) the nature of the transactions validating-transaction TR1 is dependent on (if any), etc. Additionally, such a determination may depend on a variety of factors, including, but not limited to, the following: (1) how to avoid or minimize negative dynamics, including, for instance, high-frequency oscillation scenarios where validating-transaction TR2 challenges TR1's active protective declaration, and, as a result, issues an active protective declaration only to inactivate it a microsecond later as it is challenged by TR1 that, as a result activates its protective declaration again.

According to the disclosed embodiments, validating-transaction TR2's determination of whether to challenge validating-transaction TR1's active protective declaration and when to do so depends on a variety of factors. In some embodiments, validating-transaction TR2 challenges validating-transaction TR1's active protective declaration only after it has completely performed its validation-phase and is not dependent on any other transactions. However, in other embodiments, validating-transaction TR2 may challenge validating-transaction TR1's active protective declaration earlier, later, or not at all.

Furthermore, the following paragraphs illustrate “pseudo-deadlocks” and techniques, according to various embodiments, to address them.

According to the description given hereinbefore, in an embodiment, when a validating-transaction TR1 performs an early-commitment validation for a conditional conflict for [PR1010*DCS1], by using the epsilon check, then if the epsilon check is satisfied, the validating-transaction TR1 issues an active protective declaration for [PR1010*DCS1]. Such an active protective declaration blocks other validating-transactions (e.g., TR2) from performing an early-commitment validation on [PR1010*DCS1]. Since multiple validating-transactions can, each, perform multiple early-commitment validations for multiple different combinations of predicates and data-cell sets, and since there is no well-defined order among those validations, it is possible that two, or more, validating-transactions will block each other from progressing with their early-commitment validations, creating dynamics that resembles a deadlock. The deadlock-like dynamics is denoted here as “pseudo deadlock”.

A pseudo deadlock is not a real deadlock because it may be spontaneously resolved by the commitment of reading-transaction(s) that sourced one or more of the corresponding active protective declaration, as those protective declarations will be removed, and hence the pseudo deadlock may be resolved. However, until those commitments happen, such a pseudo-deadlock behaves as a deadlock, possibly blocking validating-transactions from a possible early-commitment.

The following scenario is an example illustration of a pseudo-deadlock, according to an embodiment:

Reading-transaction TR101 and reading-transaction TR102 are reading transactions that are still running e.g., they do not complete their execution by committing or aborting.

At time t100, validating-transaction TR1 issues an active protective declaration on predicate PR1010 of data-cell-set DCS1 ([PR1010*DCS1]) sourced by reading-transaction TR101.

At time t110, validating-transaction TR2 issues an active protective declaration on predicate PR1020 of data-cell set DCS2 [PR1020*DCS2] sourced by reading-transaction TR102.

At time t120, validating-transaction TR1 wants to perform an epsilon checking procedure for [PR1020*DCS2]. Since [PR1020*DCS2] is currently blocked by an active protective declaration issued by validating-transaction TR2, validating-transaction TR1 issues an inactive evaluation-pending protective declaration on [PR1020*DCS2].

At time t130, validating-transaction TR2 wants to perform an epsilon checking procedure for [PR1010*DCS1]. Since [PR1010*DCS1] is currently blocked by an active protective declaration issued by validating-transaction TR1, validating-transaction TR2 issues an inactive evaluation-pending protective declaration on [PR1010*DCS1].

At time t140, validating-transaction TR1 completes its validation-phase and only waits on the inactive evaluation-pending protective declaration of [PR1020*DCS2]

At time t150, validating-transaction TR2 completes its validation-phase and only waits on the inactive evaluation-pending protective declaration of [PR1010*DCS1].

The above scenario is an example of a pseudo-deadlock. In some embodiments, a pseudo-deadlock may involve predicates and data-cell sets sourced by a single transaction and may involve the very same single predicate PR1010. Also, a pseudo-deadlock may involve more than two validating transactions.

The disclosed embodiments hereinbelow include techniques for resolving these pseudo-deadlocks earlier than when they would be resolved otherwise by the commitment or abortion of the reading-transaction(s) that sourced the corresponding protective declarations.

In one embodiment, these pseudo-deadlocks are resolved by performing epsilon checking procedures in a “lexicographical” ordering. The use of such an approach depends on the specific data-structure of the WV.

According to an embodiment, if a predicate of a data-cell set is evaluated by a reading-transaction TR101 while a validating-transaction TR1 already made progress with its validation process (assuming validating-transaction TR1 wrote to those data-cells), then it is possible that the validation process already passed lexicographical rank of the new conditional conflict. Under the lexicographical approach, the pertinent validations are the ones that resulted in the issuance of an active protective declaration. In one embodiment, the states of those protective declarations are inactivated in case other transactions are waiting for them (or, in another embodiment, are given up automatically in case of a challenge) and then a new validation is performed.

In another embodiment, a standard deadlock detection search is performed. This approach includes detecting a directed cycle in a graph that represents waiting of transactions on other transactions in the context of active protective declarations. According to one embodiment, once a directed cycle is found, one transaction participating in the cycle is identified, and a “sanction” against it includes cancelling the relevant active protective declaration or forcing one of the waiting transactions TR50 to agree to a challenge of another transaction TR51 that participates in the pseudo-deadlock and that is waiting on TR50's active protective declaration.

In yet another embodiment, a forced challenging procedure is performed. The procedure involves assigning each transaction a challenge rank, such that no two transactions have the same challenge rank and those with lower challenge ranks are “stronger” transactions than those with higher challenge ranks. In one embodiment, the challenge rank is set according to the timing a transaction started its validation, such that a transaction is “stronger” than another if it started its validation process earlier. However, other factors may be considered to give some transactions higher priority than others. For instance, a rank's most significant bits (MSB) may be set according to the “absolute priority class” a transaction has, while a rank's least significant bits (LSB) would be the time the transaction started its validation. Additionally, a transaction challenge rank may be modified dynamically.

According to the above embodiment, if a validating-transaction TR1 decides to perform an epsilon checking procedure for [PR1010*DCS1] and an active protection declaration for [PR1010*DCS1] issued by validating-transaction TR2 exists, then validating-transaction TR1 challenges validating-transaction TR2 (as described above). If validating-transaction TR1's challenge rank is higher (“weaker”) than validating-transaction TR2's challenge rank, then the challenge is “rejected” and validating-transaction TR1 issues an inactive evaluation-pending protective declaration. If validating-transaction TR1's challenge rank is lower (“stronger”) than validating-transaction TR2's challenge rank, then the challenge is “accepted”. This results in an active protective declaration issued by validating-transaction TR1 if the epsilon checking procedure calculates that the epsilon principle is satisfied for validating-transaction TR1 (and validating-transaction TR2 changes the state of its protective declaration to inactive evaluation-pending, etc.).

In still another embodiment, the forced challenging procedure only commences after waiting for a “timeout”. In the cases where challenging is considered too computationally demanding, waiting to see if pseudo-deadlocks are resolved naturally, as explained above, for a pre-determined amount of time is performed before the forced challenging procedure.

It should be noted that certain transactions involving referenced self-writes may cause inconsistencies when the procedures described above are applied and thus may require modifications to the procedures. According to the present disclosure, a referenced self-write is a writing operation performed by a reading-transaction, for example, TR101, to a data-cell that TR101 will later on read as part of a predicate evaluation. A referenced self-write may interfere with the procedures described above by remaining undetected and unread by a validating transaction, for example, TR1, possibly resulting in an incorrect determination that TR1 is able to commit early.

The inconsistencies that may be created by the presence of a referenced self-write may be demonstrated by the following example. According to this example, two transactions in a database are executed: TR101 and TR1. The database includes a table with rows representing employees and each row contains a plurality of characteristics for its respective employee, including hair color, salary, and profession. Within this example database, there exists an employee, “Jane,” who has blond hair and is a dentist. TR101 is a reading-transaction that first modifies Jane's hair color to “red”. Then, transaction TR101 scans all the employees, and for each employee, TR101 reads the cells corresponding to the employee's hair color and profession, and then modifies the cell for that employee's salary if the employee has red or orange hair and is a software engineer, conditions which may be denoted as predicate PR1010. TR1 is a transaction that modifies Jane's profession to “software engineer”. As TR101 executes, it will first modify “Jane's” hair color from blond to red. This modification is the referenced self-write.

It should be noted that, as part of the predictive CCP that guarantees serializability and other expected consistency properties, such a modification is done in an uncommitted manner and hence is not generally visible to other transactions. However, for the sake of serializability and other expected consistency properties, such a modification should be visible to the reading-transaction TR101 itself, if it later on reads the pertinent modified data-cell. That is, if TR101 later on reads Jane's hair color, the content it should read would be “red”. Transaction TR101 will then read on the currently committed cells with the addition of any self-written modifications. Transaction TR101 will thus read on the cells as if employee “Jane” has red hair and is a dentist. Note that prior to scanning the employees and evaluating the predicate PR1010 on each, TR101 adds a conditional RV-entry describing PR1010's evaluation.

According to the procedures described above, the cells that are read by TR101 will be inconsistent with the cells assumed to be read by TR101 from the logic of the validating transaction TR1, as TR1 would not recognize the modification of “Jane's” hair color to red by TR101. Instead, TR1 would assume that “Jane's” hair color remains blond. As TR1 executes concurrently with TR101, it will modify “Jane's” profession to “software engineer” and add the modified row to its WV. The epsilon checking procedure will then be applied to the conditional conflict detected between TR1 and TR101. The predicate of TR101, PR1010, will be evaluated for both the ε− and ε+ conditions as applied to TR1. In other words, PR1010(Jane, ε−(TR1)) and PR1010(Jane, ε+(TR1)) will be evaluated. With regards to PR1010(Jane, ε−(TR1)), it will be determined that from the perspective of TR1, at the moment before the commitment of TR1, the predicate evaluation will return a value of “FALSE” since “Jane's” hair color is assumed to be blond. With regards to PR1010(Jane, ε+(TR1)), it will be determined that from the perspective of TR1, at the moment after the commitment of TR1, the predicate evaluation will return a value of “FALSE” since “Jane's” hair color is assumed to remain blond. TR1 will thus proceed to early commitment, as the state of the conflict is classified as a stay-out state. However, this would be inconsistent with the perspective of TR101 that “Jane's” hair color is red at the time of the evaluation of PR1010. In this example, the inconsistency may result in an unrecognized moving-in state created by the committed modification by TR1 and the referenced self-write by TR101. The inconsistency may further result in a violation of serializability and other consistency expectations.

Therefore, the inconsistencies created by the presence of referenced self-writes necessitate a modification of the aforementioned procedures. A possible modification targeting the epsilon checking procedure can be described as follows. Taking the example described above, in order to align the cell contents read by TR101 with the cell contents read by TR1, the epsilon checking procedure applied to TR1 should take into account any modifications made by TR101 prior to the evaluation of PR1010. Additionally, in some embodiments, there would not be any modification of data-cells from the moment that a conditional RV-entry for PR1010 is created until the moment that PR1010 is evaluated.

According to the present disclosure, the solution to the inconsistencies created by referenced self-writes may involve the creation of a trail of ordered data-access operations. Such operations may include the creation of both RV entries and WV entries. The trail of operations may be facilitated by an Intra-Transaction Data-Access Trail Order-ID (ITDAT Order-ID) and may increase monotonously according to a real-clock timestamp, a logical timestamp (such as a counter), and the like. In an embodiment, when created, WV-entries and RV-entries are each assigned an ITDAT Order ID such that those ITDAT Order ID values are unique and monotonously increasing.

As applied to the example described above, the creation of an RV entry by TR101, the creation of a WV entry by TR101 would all be assigned an ITDAT Order ID. It should be noted that the creation of a WV entry by TR1 would also result in assigning an ITDAT Order ID, although that fact will not be used by the following description. An amended epsilon procedure may be applied to TR1 and TR101 as follows. According to the amended epsilon checking procedure, the evaluation of a predicate PR1010 for ε−(TR1) would read on the currently committed contents of the relevant data-cells, modified by any write operations by TR101 for the data-cells, up to the moment of TR101's conditional RV-entry, where the write operations modify the data-cells in the order denoted by their respective ITDAT Order-IDs. Similarly, the evaluation for ε+(TR1) would read on the currently committed contents of the relevant data-cells, modified by any write operations by TR1, and further modified by any write operations by TR101 for the data-cells, up to the moment of TR101's conditional RV-entry, where the write operations by TR101 modify the data-cells in the order denoted by their respective ITDAT Order-IDs. Utilizing this amended epsilon checking procedure, the presence of referenced self-writes may not result in an inconsistency of cell-content reads as between TR101 and TR1, and principles of serializability and consistency expectations may be preserved.

It should be noted that the amended epsilon checking procedure using ITDAT Order-IDs is merely one method for identifying and accommodating referenced self-writes. Any alternative method for accommodating referenced self-writes may be compatible with the present disclosure. For example, any alternative method that uses ordering of RV and WV entries that do not utilize ITDAT Order IDs may be compatible with the present disclosure.

The predictive CCP disclosed herein supports database operations performed on data rows. Such operations include inserting a row, deleting a row, and modifying a row. These operations are performed while maintaining the serializability and concurrency execution of transactions.

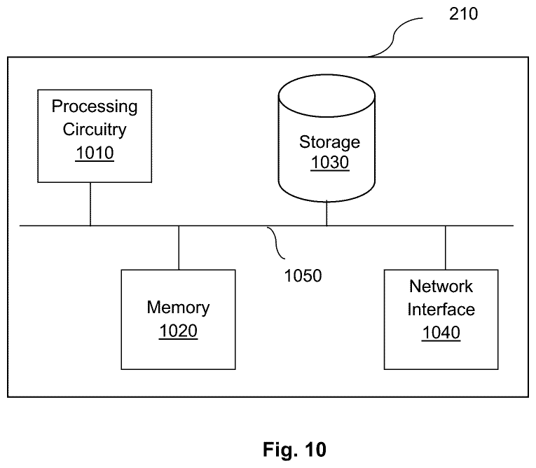

FIG. 10 is an example schematic diagram of a node 210 according to an embodiment. A node 210 includes a processing circuitry 1010 coupled to a memory 1020, a storage 1030, and a network interface 1040. In an embodiment, the components of the node 210 may be communicatively connected via a bus 1050.

The processing circuitry 1010 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 1020 may be volatile (e.g., random access memory, etc.), non-volatile (e.g., read-only memory, flash memory, etc.), or a combination thereof.

In one configuration, software for implementing one or more embodiments disclosed herein may be stored in storage 1030. In another configuration, the memory 1020 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 1010, cause the processing circuitry 1010 to perform the various processes described herein.

The storage 1030 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 1040 allows node 210 in the database system 120 to communicate with, for example, client devices, external or internal networks, and the like.

It should be understood that the embodiments described herein are not limited to the specific architecture illustrated in FIG. 10, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for managing execution of database transactions in a non-distributed database system, comprising:
during a validation of a transaction, identifying conditional conflicts and their corresponding conflicting transactions, wherein the corresponding conflicting transactions are reading-transactions conflicting with the transaction;
for each conditional conflict, determining if the transaction can commit, with respect to the conditional conflict, before the corresponding conflicting transaction;
placing an active protective declaration, issued by the transaction and sourced by a corresponding conflicting transaction, when the transaction can commit, with respect to the conditional conflict, before the corresponding conflicting transaction;
marking the transaction as dependent on the corresponding conflicting transaction when the transaction cannot commit before the corresponding conflicting transaction; and
when validation conditions are met, placing a commit pause on data cells modified by the transaction, thereby allowing the transaction to commit before any corresponding conflicting transactions.

2. The method of claim 1, further comprising:
identifying non-conditional conflicts and their related conflicting transactions.

3. The method of claim 2, wherein the validation conditions include: the transaction is neither conditionally dependent nor non-conditionally dependent on any conflicting transactions; all non-conditional conflicts are processed; all conditional conflicts are processed; the transaction does not have any evaluation-pending validations or evaluation-deferred validations; and any active protective declarations issued by the transaction are not in use by a challenging process.

4. The method of claim 2, further comprising:
waiting until the validation conditions are met.

5. The method of claim 2, further comprising:
processing all non-conditional conflicts.

6. The method of claim 5, further comprising:
for each non-conditional conflict, marking the transaction as dependent on the corresponding conflicting transaction; and
removing any protective declarations issued by the transaction that were sourced by the corresponding conflicting transaction.

7. The method of claim 2, further comprising:
processing all conditional conflicts.

8. The method of claim 7, further comprising:
checking if an epsilon checking procedure can be performed;
when the epsilon checking procedure can be performed:
performing an epsilon checking procedure on the transaction to determine if an epsilon principle is satisfied, wherein the epsilon checking procedure evaluates a value of a predicate on a data-cell set immediately before and immediately after committing the transaction;
issuing the active protective declaration for a specific predicate of a data-cell set, when the epsilon principle is satisfied; and
issuing an inactive conditionally-dependent protective declaration for a specific predicate on a specific data-cell set, when the epsilon principle is not satisfied.

9. The method of claim 8, further comprising:
when the epsilon checking procedure cannot be performed:
issuing an inactive evaluation-pending protective declaration, sourced by the conflicting transaction, wherein the inactive evaluation-pending protective declaration is issued for a specific predicate on a specific data-cell-set.

10. The method of claim 1, further comprising:
committing the transaction immediately after placing the commit pause on data cells modified by the transaction.

11. The method of claim 10, further comprising:
releasing the commit pause;
removing non-conditional dependencies of other transactions on the transaction;
removing all the active protective declarations issued by the transaction; and
removing all protective declarations sourced by the transaction.

12. The method of claim 1, wherein the corresponding conflicting transaction is a reading-transaction, and wherein reading data cells by the reading-transaction further comprises:
creating a read vector entry in a read-vector of the reading-transaction;
scanning write vectors of other pending transactions to identify conflicting writing-transactions;
for each identified conflicting writing-transactions, sending a validation message to the conflicting writing-transaction; and
reading the data cells by the reading-transaction.

13. The method of claim 1, wherein a conditional conflict is determined based, in part, on at least one predicate in the corresponding conflicting transaction.

14. The method of claim 13, wherein a state of a conditional conflict is determined as a stay-in state when evaluated values of the at least one predicate on a data cell set immediately before and immediately after committing the transaction are a Boolean value true, wherein the stay-in state provides that there is no potential dependency between the transaction and the corresponding conflicting transaction with respect to the conditional conflict.

15. The method of claim 13, wherein a state of a conditional conflict is determined as a stay-out state when evaluated values of the at least one predicate on a data cell set immediately before and immediately after committing the transaction is a Boolean value false, wherein the stay-out state provides that there is no potential dependency between the transaction and the corresponding conflicting transaction with respect to the conditional conflict.

16. The method of claim 13, wherein a state of a conditional conflict is determined as a move-in state when evaluated values of the at least one predicate on a data cell set immediately before committing the transaction is a Boolean value false, and the evaluated value of the predicate immediately after committing the transaction is a Boolean value true, wherein the move-in state does not allow the transaction to commit before the corresponding conflicting transaction.

17. The method of claim 13, wherein a state of a conditional conflict is determined as a move-out state when evaluated values of the at least one predicate on a data cell set immediately before committing the transaction is a Boolean value true, and the evaluated value of the predicate immediately after committing the transaction is a Boolean value false, wherein the move-out state does not allow the transaction to commit before the corresponding conflicting transaction.

18. The method of claim 1, wherein tasks in the transaction are executed in an optimistic manner, and wherein the transaction is validated in a pessimistic manner.

19. The method of claim 1, further comprising:
resolving pseudo-deadlocks by applying a forced challenging procedure.

20. A non-transitory computer-readable medium storing a set of instructions for managing execution of database transactions in a non-distributed database system, the set of instructions comprising:
one or more instructions that, when executed by one or more processors of a device, cause the device to:
during a validation of a transaction, identify conditional conflicts and their corresponding conflicting transactions, wherein the corresponding conflicting transactions are reading-transactions conflicting with the transaction;
for each conditional conflict, determine if the transaction can commit, with respect to the conditional conflict, before the corresponding conflicting transaction;
place an active protective declaration, issued by the transaction and sourced by a corresponding conflicting transaction, when the transaction can commit, with respect to the conditional conflict, before the corresponding conflicting transaction;
marking the transaction as dependent on the corresponding conflicting transaction when the transaction cannot commit before the corresponding conflicting transaction; and
when validation conditions are met, place a commit pause on data cells modified by the transaction, thereby allowing the transaction to commit before any corresponding conflicting transactions.

21. A system for managing execution of database transactions in a non-distributed database system comprising:
one or more processors configured to:
during a validation of a transaction, identify conditional conflicts and their corresponding conflicting transactions, wherein the corresponding conflicting transactions are reading-transactions conflicting with the transaction;
for each conditional conflict, determine if the transaction can commit, with respect to the conditional conflict, before the corresponding conflicting transaction;
place an active protective declaration, issued by the transaction and sourced by a corresponding conflicting transaction, when the transaction can commit, with respect to the conditional conflict, before the corresponding conflicting transaction;
mark the transaction as dependent on the corresponding conflicting transaction when the transaction cannot commit before the corresponding conflicting transaction; and
when validation conditions are met, place a commit pause on data cells modified by the transaction, thereby allowing the transaction to commit before any corresponding conflicting transactions.

22. The system of claim 21, wherein the one or more processors are further configured to:
identify non-conditional conflicts and their related conflicting transactions.

23. The system of claim 22, wherein the validation conditions include: the transaction is neither conditionally dependent nor non-conditionally dependent on any conflicting transactions; all non-conditional conflicts are processed; all conditional conflicts are processed; the transaction does not have any evaluation-pending validations or evaluation-deferred validations; and any active protective declarations issued by the transaction are not in use by a challenging process.

24. The system of claim 22, wherein the one or more processors are further configured to:
wait until the validation conditions are met.

25. The system of claim 22, wherein the one or more processors are further configured to:
process all non-conditional conflicts.

26. The system of claim 25, wherein the one or more processors are further configured to:
for each non-conditional conflict, mark the transaction as dependent on the corresponding conflicting transaction; and
remove any protective declarations issued by the transaction that were sourced by the corresponding conflicting transaction.

27. The system of claim 22, wherein the one or more processors are further configured to:
process all conditional conflicts.

28. The system of claim 27, wherein the one or more processors are further configured to:
check if an epsilon checking procedure can be performed;
when the epsilon check procedure can be performed:
perform an epsilon checking procedure on the transaction to determine if an epsilon principle is satisfied, wherein the epsilon checking procedure evaluates a value of a predicate on a data cell set immediately before and immediately after committing the transaction;
issue the active protective declaration for a specific predicate of a data-cell set, when the epsilon principle is satisfied; and
issue an inactive conditionally-dependent protective declaration for a specific predicate on a specific data-cell set, when the epsilon principle is not satisfied.

29. The system of claim 28, wherein the one or more processors are further configured to:
when the epsilon check procedure cannot be performed:
issue an inactive evaluation-pending protective declaration, sourced by the conflicting transaction, wherein the inactive evaluation-pending protective declaration is issued for a specific predicate on a specific data-cell-set.

30. The system of claim 21, wherein the one or more processors are further configured to:
commit the transaction immediately after placing the commit pause on data cells modified by the transaction.

31. The system of claim 30, wherein the one or more processors are further configured to:
release the commit pause;
remove non-conditional dependencies of other transactions on the transaction;
remove all the active protective declarations issued by the transaction; and
remove all protective declarations sourced by the transaction.

32. The system of claim 21, wherein the one or more processors, when the corresponding conflicting transaction is a reading-transaction, are further configured to:
create a read vector entry in a read-vector of the reading-transaction;
scan write vectors of other pending transactions to identify conflicting writing transactions;
for each identified conflict writing-transactions, send a validation message to the conflicting writing-transaction; and
read the data cells by the reading-transaction.

33. The system of claim 21, wherein a conditional conflict is determined based, in part, on at least one predicate in the corresponding conflicting transaction.

34. The system of claim 33, wherein a state of a conditional conflict is determined as a stay-in state when evaluated values of the at least one predicate on a data cell set immediately before and immediately after committing the transaction are a Boolean value true, the stay-in state provides that there is no potential dependency between the transaction and the corresponding conflicting transaction with respect to the conditional conflict.

35. The system of claim 33, wherein a state of a conditional conflict is determined as a stay-out state when evaluated values of the at least one predicate on a data cell set immediately before and immediately after committing the transaction is a Boolean value false, the stay-out state provides that there is no potential dependency between the transaction and the corresponding conflicting transaction with respect to the conditional conflict.

36. The system of claim 33, wherein a state of a conditional conflict is determined as a move-in state when evaluated values of the at least one predicate on a data cell set immediately before committing the transaction is a Boolean value false, and the evaluated value of the predicate immediately after committing the transaction is a Boolean value true, the move-in state does not allow the transaction to commit before the corresponding conflicting transaction.

37. The system of claim 33, wherein a state of a conditional conflict is determined as a move-out state when evaluated values of the at least one predicate on a data cell set immediately before committing the transaction is a Boolean value true, and the evaluated value of the predicate immediately after committing the transaction is a Boolean value false, the move-out state does not allow the transaction to commit before the corresponding conflicting transaction.

38. The system of claim 21, wherein tasks in the transaction are executed in an optimistic manner, and wherein the transaction is validated in a pessimistic manner.

39. The system of claim 21, wherein the one or more processors are further configured to:
resolve pseudo-deadlocks by applying a forced challenging procedure.
